(19) United States
(12) Patent Application Publication
(10) Pub. No.: US 2010/0280809 A1
(43) Pub. Date: Nov. 4, 2010

(54) Biological state-evaluating apparatus, biological state-evaluating method, biological state-evaluating system, biological state-evaluating program and recording medium

(75) Inventors: Mitsuo Takahashi, Kanagawa (JP); Toshihiko Ando, Kanagawa (JP)

Correspondence Address: FOLEY AND LARDNER LLP;SUITE 500, 3000 K STREET NW, WASHINGTON, DC, 20007, US

(73) Assignee: Ajinomoto Co., Inc.

(21) Appl. No.: 12/662,560

(22) Filed: Apr. 22, 2010

Related U.S. Application Data
(63) Continuation of application No. PCT/JP2008/068982, filed on Oct. 20, 2008.

(30) Foreign Application Priority Data
Oct. 25, 2007 (JP) 2007-277794

(51) Int. Cl. G06G 7/48

(52) U.S. Cl. 703/11

(57) ABSTRACT

An object is to provide a biological state-evaluating apparatus, a biological state-evaluating method, a biological state-evaluating system, a biological state-evaluating program, and a recording medium that can evaluate a biological state with high accuracy by using the concentrations of amino acids in blood. According to the present invention, a Bayesian network method is performed by using previously obtained amino acid concentration data on the concentration values of amino acids and previously obtained biological state data on the numerical value indicative of the biological state so that a Bayesian network model that includes, as explanatory variables, the concentration values of amino acids and the numerical value indicative of the biological state is created, and the biological state of the subject is evaluated by using the created Bayesian network model and the previously obtained amino acid concentration data on the subject.

This application is a Continuation of PCT/JP2008/068982, filed Oct. 20, 2008, which claims priority from Japanese patent application JP 2007-277794 filed Oct. 25, 2007. The contents of each of the aforementioned application are incorporated herein by reference in their entirety.

### BACKGROUND OF THE INVENTION

1. Field of the Invention

The present invention relates to a biological state-evaluating apparatus, a biological state-evaluating method, a biological state-evaluating system, a biological state-evaluating program, and a recording medium that utilize the concentrations of amino acids in blood (plasma).

In the present specification, the “biological state” is a concept including a healthy state (healthiness) and various disease states.

2. Description of the Related Art

Biomarkers which are effective for diagnosing are being searched for using as a diagnostic method as to whether a healthy state or a disease state of a biological state, various methods as to gene expression, proteome, metabolome and so on, based on new techniques (gene expression analysis, proteome analysis, metabolome analysis for analysis of metabolites and so on) for post-genome era with the development in the genomic analysis of recent date.

Since a metabolite concentration reflects a dynamic equilibrium caused by various metabolic factors in the body, change in biological state is thought to lead to change in a metabolite concentration. Conversely, change in a biological state (whether a healthy state or a disease state of the biological state) can be evaluated by observing change in a metabolite concentration.

Heretofore, it is known that as an example of evaluating method for a disease state according to change in the concentration of an amino acid, which is a metabolite in blood, the Fischer ratio, the “ratio between sum of branched-chain amino acids and sum of aromatic amino acids: (Leu+Ile+Val)/(Phe+Tyr)” decreases during liver cirrhosis (see J. E. Fischer, et al., Surgery, 78, 276, 1975). Like the evaluating method using the Fischer ratio, since a metabolite concentration varies according to correlated changes of multiple metabolites, a multivariate evaluating method using the concentrations of multiple metabolites as explanatory variables is suitable for evaluation of the biological state.

As evaluating techniques of biological state based on a metabolite concentration except for that of the Fischer ratio, U.S. Pat. No. 5,687,716, International Publication WO 2004/052191, and International Publication WO 2006/098192 are known. U.S. Pat. No. 5,687,716 discloses an evaluating method using neural network, which is model of neuron, based on data on metabolite, or the like. Specifically, blood analysis data of healthy people and patients with heart disease or dental amalgam syndrome is used as training data to create evaluation model as to neural network, and blood analysis data of a new subject to be evaluated is applied to the created evaluation model in order to predict a disease state of heart disease, dental amalgam syndrome, or the like, of the subject to be evaluated. International Publication WO 2004/052191 discloses a method of analyzing correlativity between indicator data on biological state and explanatory variables of multiple metabolite concentrations including amino acid concentration in blood in order to generate a correlation formula having multivariable fractional expressions. Specially, an evaluation index for determining disease state of hepatic fibrosis is generated as a correlation formula having the fractional expressions using multiple explanatory variables of amino acids. International Publication WO 2006/098192 discloses an evaluating method by multivariate analysis of index data on biological state, as an evaluation object, including combination of explanatory variables of multiple metabolite concentrations including amino acid concentration in blood. Selection of evaluating methods according to the multivariate analysis includes means for verifying evaluation function and explanatory variable-selecting means for selecting combination of the explanatory variables. Specially, an evaluation function having explanatory variables of multiple amino acids according to the multivariate analysis is generated for determining a disease state of Crohn's disease or ulcerative colitis. As mentioned above, International Publications WO 2004/052191 and WO 2006/098192 describe that an evaluation index for discrimination of biological state is obtained by using amino acid concentrations in blood for evaluation of the biological state.

As a technique using Bayesian network (hereinafter referred to sometimes by the abbreviation “BN”) for medical diagnosis, the followings are known: Wiegerinck, WAJJ. And Braak ter E., 1998, PROMEDAS, “a prototype decision support system for medical diagnosis.”; PDF file introduced at PROMEDAS homepage: http://www.promedas.nl/doc/promedasvl.pdf; and Onisko A, et al., Research Report, CBMI-99-27, 1, 1999. These documents disclose that stochastic determination assistance system as to medical diagnosis is provided for support for diagnosing or medical education. According to Wiegerinck, WAJJ. And Braak ter E., 1998, PROMEDAS, and the PDF file introduced at the PROMEDAS homepage, BN structure is built based on knowledge of medical professional, using explanatory variables of symptomatic state of a subject to be evaluated, measurement data, medical records and so on for more than 100 varieties of disorders such as circulatory system disease and lymphoma. According to Onisko A, et al., Research Report, CBMI-99-27, 1, 1999, BN structure is built for output of 16 varieties of hepatopathy for support for diagnosing liver disease, based on knowledge of medical professional, using 93 explanatory variables of measurement data and data of interview usually done by a medical doctor in field of liver disease, and the prediction by using a BN is verified using a leave-one-out method.

However, according to conventional technology, there are problems in that a qualitative causal relation or dependency relation between the biological state and explanatory variables such as metabolites is not considered in a positive way at the stage for generating a method of evaluating the biological state using the metabolite, and biological findings between the biological state and an explanatory variable such as a metabolite is not reflected.

Conventional technology also has a problem in that, if normality of explanatory variable data distribution or a linear relation between explanatory variables is hypothesized, various distributions and dependency relations of explanatory variable data cannot be reflected.

Although it is important to build BN structure by discriminating between explanatory variables necessary for evaluation and explanatory variables that are not important therefor in an evaluating method of biological state using the BN method so as to improve evaluation performance, there is a problem in that this aspect is not sufficiently considered in an evaluating method for biological state using the BN method according to conventional technology. Further, because biological state is thought to vary in association with change in metabolite concentration such as amino acid concentration in blood plasma, detailed evaluation of biological state is possible by using amino acids in blood plasma, or the like, as explanatory variables for the BN method; however, this is not considered in an evaluating method for biological state using the BN method according to conventional technology.

### SUMMARY OF THE INVENTION

It is an object of the present invention to at least partially solve the problems in the conventional technology. The present invention is made in view of the problem described above, and an object of the present invention is to provide a biological state-evaluating apparatus, a biological state-evaluating method, a biological state-evaluating system, a biological state-evaluating program, and a recording medium that can evaluate biological state with high accuracy by utilizing amino acid concentrations in blood plasma.

To solve the problem and achieve the object described above, a biological state-evaluating apparatus according to one aspect of the present invention includes a control unit to evaluate a biological state of a subject to be evaluated. The control unit includes a model creating unit that creates, by performing a Bayesian network method by using previously obtained amino acid concentration data on a concentration value of an amino acid and previously obtained biological state data on a numerical value indicative of the biological state, a Bayesian network model that includes, as the explanatory variables, the concentration value of the amino acid and the numerical value indicative of the biological state, and a biological state-evaluating unit that evaluates the biological state of the subject by using the Bayesian network model created by the model creating unit and the previously obtained amino acid concentration data on the subject.

Another aspect of the present invention is the biological state-evaluating apparatus, wherein the control unit further includes an explanatory variable-selecting unit that selects, from the concentration values of the respective amino acids constituting the amino acid concentration data, a concentration value to be used as the explanatory variable for performing the Bayesian network method by a predetermined method.

Still another aspect of the present invention is the biological state-evaluating apparatus, wherein the predetermined method is a multivariate analysis method or a search method of Bayesian network structure.

Still another aspect of the present invention is the biological state-evaluating apparatus, wherein the Bayesian network model further includes, as the explanatory variable, any one of the numerical value of any one of a biological metabolite and a biological indicator or both that have a dependency relation with the concentration value of the amino acid, and the numerical value of any one of the biological metabolite and the biological indicator or both that have a dependency relation with the numerical value indicative of the biological state, or both.

Still another aspect of the present invention is the biological state-evaluating apparatus, wherein the biological metabolite is at least one of carbohydrate, lipid, protein, peptide, mineral, and hormone, and the biological indicator is at least one of blood glucose, blood pressure, sex, age, disease indicator, dietary habit, drinking habit, sport habit, degree of obesity, and disease history.

Still another aspect of the present invention is the biological state-evaluating apparatus, wherein the biological state-evaluating unit further includes a biological state-discriminating unit that discriminates between a healthy state and a disease state of the biological state of the subject by using the Bayesian network model created by the model creating unit and the previously obtained amino acid concentration data on the subject.

Still another aspect of the present invention is the biological state-evaluating apparatus, wherein the biological state is a state of impaired glucose tolerance.

Still another aspect of the present invention is the biological state-evaluating apparatus, wherein the amino acid concentration data on the subject is measured from blood that is collected from the subject to whom a desired substance group consisting of one or more substances has been administered, and the control unit further includes a determining unit that determines whether the desired substance group prevents the impaired glucose tolerance or ameliorates the state of the impaired glucose tolerance by using an evaluation result obtained by the biological state-evaluating unit.

The present invention also relates to a biological state-evaluating method, and one aspect of the present invention is the biological state-evaluating method of evaluating a biological state of a subject to be evaluated. The method is carried out with an information processing apparatus including a control unit. The method includes a model creating step of creating, by performing a Bayesian network method by using previously obtained amino acid concentration data on a concentration value of an amino acid and previously obtained biological state data on a numerical value indicative of the biological state, a Bayesian network model that includes, as the explanatory variables, the concentration value of the amino acid and the numerical value indicative of the biological state, and (ii) a biological state-evaluating step of evaluating the biological state of the subject by using the Bayesian network model created at the model creating step and the previously obtained amino acid concentration data on the subject. The steps (i) and (ii) are executed by the control unit.

Another aspect of the present invention is the biological state-evaluating method, wherein the control unit further executes an explanatory variable-selecting step of selecting, from the concentration values of the respective amino acids constituting the amino acid concentration data, a concentration value to be used as the explanatory variable for performing the Bayesian network method by a predetermined method.

Still another aspect of the present invention is the biological state-evaluating method, wherein the predetermined method is a multivariate analysis method or a search method of Bayesian network structure.

Still another aspect of the present invention is the biological state-evaluating method, wherein the Bayesian network model further includes, as the explanatory variable, any one of the numerical value of any one of a biological metabolite and a biological indicator or both that have a dependency relation with the concentration value of the amino acid, and the numerical value of any one of the biological metabolite and the biological indicator or both that have a dependency relation with the numerical value indicative of the biological state, or both.

Still another aspect of the present invention is the biological state-evaluating method, wherein the biological metabolite is at least one of carbohydrate, lipid, protein, peptide, mineral, and hormone, and the biological indicator is at least one of blood glucose, blood pressure, sex, age, disease indicator, dietary habit, drinking habit, sport habit, degree of obesity, and disease history.

Still another aspect of the present invention is the biological state-evaluating method, wherein the biological state-evaluating step further includes a biological state-discriminating step of discriminating between a healthy state and a disease state of the biological state of the subject by using the Bayesian network model created at the model creating step and the previously obtained amino acid concentration data on the subject.

Still another aspect of the present invention is the biological state-evaluating method, wherein the biological state is a state of impaired glucose tolerance.

Still another aspect of the present invention is the biological state-evaluating method, wherein the amino acid concentration data on the subject is measured from blood that is collected from the subject to whom a desired substance group consisting of one or more substances has been administered, and the control unit further executes a determining step of determining whether the desired substance group prevents the impaired glucose tolerance or ameliorates the state of the impaired glucose tolerance by using an evaluation result obtained at the biological state-evaluating step.

The present invention also relates to a biological state-evaluating system, the biological state-evaluating system according to one aspect of the present invention is configured by communicatively connecting, via a network, a biological state-evaluating apparatus that includes a control unit to evaluate a biological state of a subject to be evaluated and an information communication terminal apparatus that provides amino acid concentration data on a concentration value of an amino acid of the subject. The information communication terminal apparatus includes an amino acid concentration data-sending unit that sends the amino acid concentration data on the subject to the biological state-evaluating apparatus, and an evaluation result-receiving unit that receives an evaluation result relating to the biological state of the subject that is sent from the biological state-evaluating apparatus. The control unit of the biological state-evaluating apparatus includes an amino acid concentration data-receiving unit that receives the amino acid concentration data on the subject that is sent from the information communication terminal apparatus, a model creating unit that creates, by performing a Bayesian network method by using the previously obtained amino acid concentration data and previously obtained biological state data on a numerical value indicative of the biological state, a Bayesian network model that includes, as the explanatory variables, the concentration value of the amino acid and the numerical value indicative of the biological state, a biological state-evaluating unit that evaluates the biological state of the subject by using the Bayesian network model created by the model creating unit and the amino acid concentration data on the subject that is received by the amino acid concentration data-receiving unit, and an evaluation result-sending unit that sends the evaluation result obtained by the biological state-evaluating unit to the information communication terminal apparatus.

Another aspect of the present invention is the biological state-evaluating system, wherein the control unit of the biological state-evaluating apparatus further includes an explanatory variable-selecting unit that selects, from the concentration values of the respective amino acids constituting the amino acid concentration data, a concentration value to be used as the explanatory variable for performing the Bayesian network method by a predetermined method.

Still another aspect of the present invention is the biological state-evaluating system, wherein the predetermined method is a multivariate analysis method or a search method of Bayesian network structure.

Still another aspect of the present invention is the biological state-evaluating system, wherein the Bayesian network model further includes, as the explanatory variable, any one of the numerical value of any one of a biological metabolite and a biological indicator or both that have a dependency relation with the concentration value of the amino acid, and the numerical value of any one of the biological metabolite and the biological indicator or both that have a dependency relation with the numerical value indicative of the biological state, or both.

Still another aspect of the present invention is the biological state-evaluating system, wherein the biological metabolite is at least one of carbohydrate, lipid, protein, peptide, mineral, and hormone, and the biological indicator is at least one of blood glucose, blood pressure, sex, age, disease indicator, dietary habit, drinking habit, sport habit, degree of obesity, and disease history.

Still another aspect of the present invention is the biological state-evaluating system, wherein the biological state-evaluating unit further includes a biological state-discriminating unit that discriminates between a healthy state and a disease state of the biological state of the subject by using the Bayesian network model created by the model creating unit and the previously obtained amino acid concentration data on the subject.

Still another aspect of the present invention is the biological state-evaluating system, wherein the biological state is a state of impaired glucose tolerance.

Still another aspect of the present invention is the biological state-evaluating system, wherein the amino acid concentration data on the subject is measured from blood that is collected from the subject to whom a desired substance group consisting of one or more substances has been administered, and the control unit of the biological state-evaluating apparatus further includes a determining unit that determines whether the desired substance group prevents the impaired glucose tolerance or ameliorates the state of the impaired glucose tolerance by using an evaluation result obtained by the biological state-evaluating unit.

The present invention also relates to a biological state-evaluating program product, one aspect of the present invention is the biological state-evaluating program product that makes an information processing apparatus including a control unit execute a method of evaluating a biological state of a subject to be evaluated. The method includes (i) a model creating step of creating, by performing a Bayesian network method by using previously obtained amino acid concentration data on a concentration value of an amino acid and previously obtained biological state data on a numerical value indicative of the biological state, a Bayesian network model that includes, as the explanatory variables, the concentration value of the amino acid and the numerical value indicative of the biological state, and (ii) a biological state-evaluating step of evaluating the biological state of the subject by using the Bayesian network model created at the model creating step and the previously obtained amino acid concentration data on the subject. The steps (i) and (ii) are executed by the control unit.

Another aspect of the present invention is the biological state-evaluating program product, wherein the control unit further executes an explanatory variable-selecting step of selecting, from the concentration values of the respective amino acids constituting the amino acid concentration data, a concentration value to be used as the explanatory variable for performing the Bayesian network method by a predetermined method.

Still another aspect of the present invention is the biological state-evaluating program product, wherein the predetermined method is a multivariate analysis method or a search method of Bayesian network structure.

Still another aspect of the present invention is the biological state-evaluating program product, wherein the Bayesian network model further includes, as the explanatory variable, any one of the numerical value of any one of a biological metabolite and a biological indicator or both that have a dependency relation with the concentration value of the amino acid, and the numerical value of any one of the biological metabolite and the biological indicator or both that have a dependency relation with the numerical value indicative of the biological state, or both.

Still another aspect of the present invention is the biological state-evaluating program product, wherein the biological metabolite is at least one of carbohydrate, lipid, protein, peptide, mineral, and hormone, and the biological indicator is at least one of blood glucose, blood pressure, sex, age, disease indicator, dietary habit, drinking habit, sport habit, degree of obesity, and disease history.

Still another aspect of the present invention is the biological state-evaluating program product, wherein the biological state-evaluating step further includes a biological state-discriminating step of discriminating between a healthy state and a disease state of the biological state of the subject by using the Bayesian network model created at the model creating step and the previously obtained amino acid concentration data on the subject.

Still another aspect of the present invention is the biological state-evaluating program product, wherein the biological state is a state of impaired glucose tolerance.

Still another aspect of the present invention is the biological state-evaluating program product, wherein the amino acid concentration data on the subject is measured from blood that is collected from the subject to whom a desired substance group consisting of one or more substances has been administered, and the control unit further executes a determining step of determining whether the desired substance group prevents the impaired glucose tolerance or ameliorates the state of the impaired glucose tolerance by using an evaluation result obtained at the biological state-evaluating step.

The present invention also relates to a recording medium, the recording medium according to one aspect of the present invention includes the breast cancer biological state-evaluating program product described above.

According to the biological state-evaluating apparatus, the biological state-evaluating method, the biological state-evaluating system, and the biological state-evaluating program of the present invention, the Bayesian network method is performed by using amino acid concentration data on the concentration values of amino acids and biological state data on the numerical value indicative of the biological state so as to create a Bayesian network model that includes, as explanatory variables, the concentration values of amino acids and the numerical value indicative of the biological state, and the biological state of a subject to be evaluated is evaluated by using the created Bayesian network model and the amino acid concentration data on the subject, whereby an advantage is produced such that the biological state can be evaluated with high accuracy by using the BN model that includes the amino acid concentration in blood.

According to the biological state-evaluating apparatus, the biological state-evaluating method, the biological state-evaluating system, and the biological state-evaluating program of the present invention, concentration values to be used as explanatory variables for performing the Bayesian network method are selected from the concentration values of respective amino acids constituting the amino acid concentration data by using a predetermined method so that advantages are produced such that amino acids in blood plasma that have a significant dependency relation with the biological state can be selected and, as a result, the biological state can be evaluated with higher accuracy.

According to the biological state-evaluating apparatus, the biological state-evaluating method, the biological state-evaluating system, and the biological state-evaluating program of the present invention, the predetermined method is a multivariate analysis method or a search method of Bayesian network structure so that advantages are produced such that amino acids in blood plasma that have a significant dependency relation with the biological state can be efficiently selected by using an existing method and, as a result, the biological state can be evaluated with higher accuracy.

According to the biological state-evaluating apparatus, the biological state-evaluating method, the biological state-evaluating system, and the biological state-evaluating program of the present invention, the Bayesian network model further includes, as explanatory variables, any one of the numerical value of any one of a biological metabolite and a biological indicator or both that have a dependency relation with the concentration value of an amino acid, and the numerical value of any one of a biological metabolite and a biological indicator or both that have a dependency relation with the numerical value indicative of the biological state, or both, whereby advantages are produced such that various explanatory variables that have a significant dependency relation with the amino acid or the biological state can be used and, as a result, the biological state can be evaluated with higher accuracy.

According to the biological state-evaluating apparatus, the biological state-evaluating method, the biological state-evaluating system, and the biological state-evaluating program of the present invention, the biological metabolite is at least one of carbohydrate, lipid, protein, peptide, mineral, and hormone, and the biological indicator is at least one of blood glucose, blood pressure, sex, age, disease indicator, dietary habit, drinking habit, sport habit, degree of obesity, and disease history, whereby advantages are produced such that it is possible to use explanatory variables that can be collected easily and, as a result, to evaluate the biological state with higher accuracy.

According to the biological state-evaluating apparatus, the biological state-evaluating method, the biological state-evaluating system, and the biological state-evaluating program of the present invention, discrimination is performed to determine whether the biological state of the subject is a healthy state or a disease state by using the created Bayesian network model and the amino acid concentration data on the subject so that an advantage is produced such that discrimination between two groups as to whether the biological state is a healthy state or a disease state can be performed with high accuracy by using the BN model that includes the amino acid concentrations in blood as explanatory variables.

According to the biological state-evaluating apparatus, the biological state-evaluating method, the biological state-evaluating system, and the biological state-evaluating program of the present invention, the biological state is the state of impaired glucose tolerance so that an advantage is produced such that evaluation of the state of impaired glucose tolerance (specifically, discrimination between the two groups: impaired glucose tolerance or normal) can be performed with high accuracy by using the BN model that includes the amino acid concentrations in blood as explanatory variables.

According to the biological state-evaluating apparatus, the biological state-evaluating method, the biological state-evaluating system, and the biological state-evaluating program of the present invention, the amino acid concentration data on the subject is measured from blood that is collected from the subject to whom a desired substance group consisting of one or more substances has been administered and, in accordance with an evaluation result, it is determined whether the desired substance group prevents impaired glucose tolerance or ameliorates the state of impaired glucose tolerance, whereby an advantage is produced such that a substance that prevents or ameliorates impaired glucose tolerance can be searched for with high accuracy by using the result of evaluation of the state of impaired glucose tolerance (specifically, discrimination between two groups: impaired glucose tolerance or normal) that is performed by using the BN model that includes the amino aid concentrations in blood as explanatory variables.

According to the recording medium of the present invention, the biological state-evaluating program stored on the recording medium is read and executed by a computer so that the computer executes the biological state-evaluating program, whereby an advantage is produced such that the same advantage as using the biological state-evaluating program can be obtained.

The above and other objects, features, advantages and technical and industrial significance of this invention will be better understood by reading the following detailed description of presently preferred embodiments of the invention, when considered in connection with the accompanying drawings.

### BRIEF DESCRIPTION OF DRAWINGS

FIG. 1 is a diagram showing the outline of the present invention;

FIG. 2 is a diagram showing an example of the entire configuration of the present system;

FIG. 3 is a diagram showing another example of the entire configuration of the present system;

FIG. 4 is a block diagram showing an example of the configuration of a biological state-evaluating apparatus 100 in the present system;

FIG. 5 is a chart showing an example of information stored in a user information file 106a;

FIG. 6 is a chart showing an example of information stored in a biological state information file 106b;

FIG. 7 is a Chart showing an example of information stored in a BN model file 106c;

FIG. 8 is a chart showing information stored in an evaluation result file 106d;

FIG. 9 is a block diagram showing an example of the configuration of a client apparatus 200 in the present system;

FIG. 10 is a block diagram showing an example of the configuration of a database apparatus 400 in the present system;

FIG. 11 is a flowchart showing an example of a biological state evaluation service process performed by the present system;

FIG. 12 is a flowchart showing an example of a biological state evaluation process performed by the biological state-evaluating apparatus 100;

FIG. 13 is a diagram showing BN structure created according to Example 1;

FIG. 14 is a boxplot showing the distribution of amino acid explanatory variables in two groups: normal and impaired glucose tolerance;

FIG. 15 is a diagram showing BN structure created according to Example 2;

FIG. 16 is a diagram showing BN structure created according to Example 3;

FIG. 17 is a diagram showing ROC curves in order to evaluate discrimination performance between the two groups;

FIG. 18 is a diagram showing BN structure created according to Example 3;

FIG. 19 is a diagram showing BN structure created according to Example 4; and

FIG. 20 is a diagram showing ROC curves used to evaluate discrimination performance between the two groups.

### DETAILED DESCRIPTION OF THE PREFERRED EMBODIMENTS

Herein, a detailed explanation is given of embodiments of a biological state-evaluating apparatus, a biological state-evaluating method, a biological state-evaluating system, a biological state-evaluating program, and a recording medium according to the present invention with reference to the drawings. The present invention is not limited to the embodiments.

### 1. Outline of the Present Invention

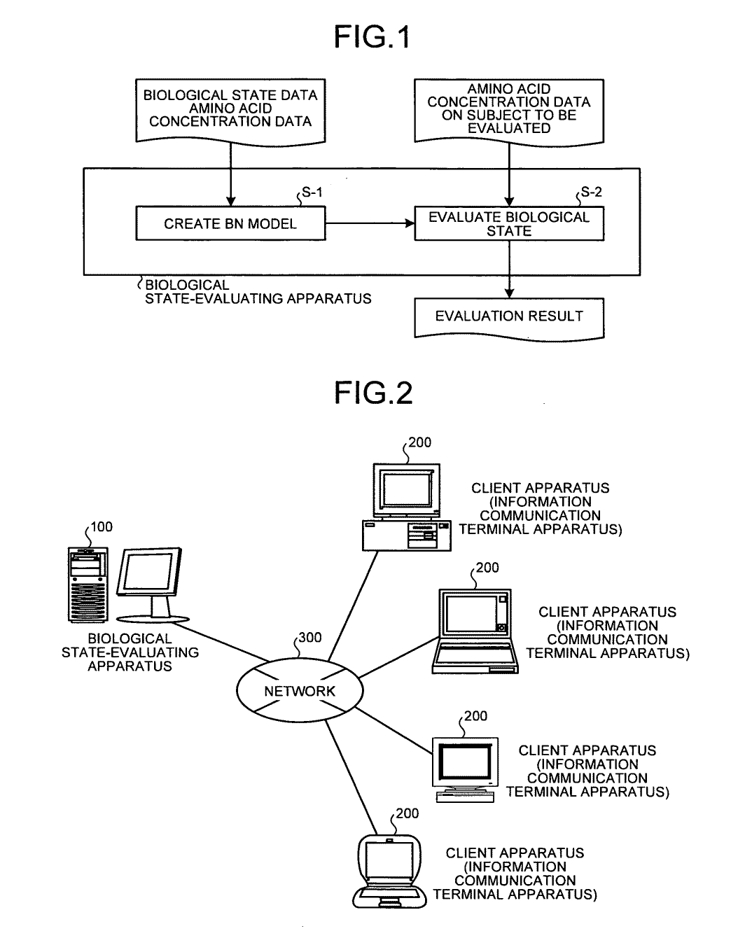

Here, an explanation is given of the outline of the present invention with reference to FIG. 1. FIG. 1 is a diagram showing the outline of the present invention.

According to the present invention, a control unit performs the BN method using the previously obtained amino acid concentration data for training on concentration values of amino acids and the previously obtained biological state data on a numerical value indicative of a biological state and using the concentration values of the amino acids and the numerical value indicative of the biological state as explanatory variables, thereby creating a BN model that includes the concentration values of the amino acids and the numerical value indicative of the biological state as explanatory variables (step S-1).

In step S-1, the amino acid concentration data for training was measured from a blood sample that was collected from a subject (for example, an individual such as an animal or a human). The concentrations of amino acids in blood were analyzed in the following manner. A blood sample obtained was collected in a heparin-treated tube, and then the blood plasma was separated from the blood by centrifugation of the collected blood sample. All blood plasma samples were frozen and stored at −70° C. before measurement of amino acid concentration. Before measurement of amino acid concentration, the blood plasma sample was deproteinized by adding sulfosalicylic acid to a concentration of 3%, and an amino acid analyzer employing the principle of high-performance liquid chromatography (HPLC) using a ninhydrin reaction in the post column was used for measuring. The unit of amino acid concentration may be, for example, molar concentration, weight concentration, or these concentrations which are subjected to addition, subtraction, multiplication and division by an arbitrary constant.

Then, according to the present invention, the control unit evaluates the biological state of a subject to be evaluated (for example, an individual such as an animal or a human) by using the BN model created in step S-1 and the previously obtained amino acid concentration data on the subject (step S-2).

As described above, according to the present invention, the BN method is performed by using the previously obtained amino acid concentration data for training and the biological state data so as to create a BN model that includes the concentration values of amino acids and the numerical value indicative of the biological state as explanatory variables, and the biological state of the subject is evaluated by using the created BN model and the previously obtained amino acid concentration data on the subject.

In other words, according to the present invention, the concentrations of amino acids in blood plasma are used as variable quantities (explanatory variables) to evaluate the biological state (for example, to discriminate between a healthy state or a disease state of the biological state) and the BN method is used as an evaluation method so as to create a BN model, and the biological state of a new sample is evaluated by using the created BN model. According to the present invention, explanatory variables contained in the BN model include amino acid concentration in blood plasma and a biological state explanatory variable indicative of a biological state. In the present invention, a graph structure that represents a qualitative causal relation or dependency relation between random variables such as amino acids and a biological state is searched for, and conditional probability that indicates a quantitative dependency relation between the respective random variables is obtained. According to the present invention, the causal relation or dependency relation between explanatory variables such as biological state and amino acids is considered and these relations are represented by a network in which explanatory variables are correlated with each other.

Thus, the biological state can be evaluated with high accuracy by using the BN model that includes amino acid concentrations in blood plasma as explanatory variables. In the present invention, there is no need to assume the normality of distribution of explanatory variable values or the linear relation between explanatory variables. Further, according to the present invention, with regard to conditional probability, normal distribution may be assumed for a continuous variable or normal distribution may not be assumed therefor. Specifically, in the present invention, non-normal probability distribution, for which the normality is not assumed and which is divided into N sections for general purpose, may be used for calculating conditional probability.

According to the present invention, concentration values to be used as explanatory variables for performing the BN method may be selected from the concentration values of respective amino acids constituting amino acid concentration data by using a predetermined method. In this manner, it is possible to select amino acids in blood plasma that have a significant dependency relation with the biological state and, as a result, evaluate the biological state with higher accuracy. That is, evaluation performance of the biological state using a BN can be improved.

According to the present invention, the predetermined method may be, for example, a multivariate analysis method or a search method of Bayesian network structure. Thus, amino acids in blood plasma that have a significant dependency relation with the biological state can be efficiently selected by using an existing method and, as a result, the biological state can be evaluated with higher accuracy.

For example, an explanatory variable included in an evaluation formula for multivariate analysis by explanatory variable selection as disclosed in International Publication WO 2006/098192 may be used as a node for a BN. Specifically, an explanatory variable included in a logistic regression formula by the stepwise method may be selected as a node for the BN. Thus, evaluation performance of the biological state by using the BN can be improved.

A graph structure that includes candidate explanatory variables is searched for by using, for example, an exhaustive search method or a K2 algorithm using a greedy algorithm so that the network structure of the BN that reflects a qualitative causal relation or dependency relation between explanatory variables is obtained with an optimal evaluation index (for example, AIC (Akaike Information Criterion), BIC (Bayesian Information Criterion), or MDL (Minimum Description Length)) determined depending on the structure, and explanatory variables included in the obtained optimal network structure may be selected. Thus, evaluation performance of the biological state by using a BN can be improved.

According to the present invention, the BN model may further include, as explanatory variables, for example, the numerical value of a biological metabolite or the numerical value of a biological indicator that has a dependency relation with the concentration value of an amino acid, the numerical value of a biological metabolite or the numerical value of a biological indicator that has a dependency relation with the numerical value indicative of the biological state. Thus, it is possible to take various explanatory variables that have a significant dependency relation with amino acids or biological state and, as a result, to evaluate the biological state with higher accuracy. According to the present invention, the biological metabolite may be, for example, carbohydrate, lipid, protein, peptide, mineral, or hormone, and the biological indicator may be, for example, blood glucose, blood pressure, sex, age, disease indicator, dietary habit, drinking habit, sport habit, degree of obesity, or disease history, or they may be combined as an explanatory variable for a BN model. In this manner, it is possible to use explanatory variables that can be collected easily and, as a result, to evaluate the biological state with higher accuracy. Explanatory variables included in a BN model may be continuous variables or discrete variables.

According to the present invention, discrimination as to whether the biological state of a subject to be evaluated is a healthy state or a disease state may be performed by using the created BN model and the previously obtained amino acid concentration data. Thus, the discrimination between two groups as to whether the biological state is a healthy state or a disease state can be performed with high accuracy by using the BN model that includes amino acid concentrations in blood plasma as explanatory variables. If the biological state is discriminated between, for example, a healthy state and a disease state, a biological state explanatory variable may be a discrete variable (for example, “0” for a healthy state and “1” for a disease state).

According to the present invention, the biological state may be, for example, the state of impaired glucose tolerance. Thus, evaluation of the state of impaired glucose tolerance (specifically, discrimination between the two groups: impaired glucose tolerance or normal) can be performed with high accuracy by using a BN model that includes amino acid concentrations in blood plasma as explanatory variables. In the present invention, explanatory variables of the BN method include an amino acid concentration explanatory variable indicative of the amino acid concentration in blood plasma and a biological state explanatory variable indicative of the biological state (the state of impaired glucose tolerance). The biological state explanatory variable may be a discrete variable and, specifically, may be an explanatory variable with a value of “0” for a healthy state and “1” for impaired glucose tolerance. Further, explanatory variables of the BN method include, in addition to the amino acid concentration explanatory variable and the biological state explanatory variable, a fasting plasma glucose (FPG) level that has a dependency relation with impaired glucose tolerance, a sex explanatory variable (“1” for men and “2” for women) for representing gender difference in amino acid concentration distribution, and the like.

An explanation is given of the evaluation of the state of impaired glucose tolerance, which has been a focus of attention in relation to lifestyle diseases, as an example of the evaluation of biological state according to the present invention.

According to the survey on the actual conditions of diabetes conducted by the Ministry of Health, Labor and Welfare in 2002 across Japan, “people who are highly suspected of diabetes (people with Hemoglobin A1c (HbA1C) of equal to or more than 6.1% or people currently undergoing treatment for diabetes)” number about 7.4 million, “people for whom the possibility of diabetes cannot be denied (people with HbA1C of equal to or more than 5.6% and less than 6.1% and who are not currently undergoing any treatment for diabetes)” number about 8.8 million, and the total thereof reaches about 16.2 million. That is, it is estimated that one out of six adults has diabetes or prediabetes. This survey reveals the actual conditions of diabetes, which is called the “national disease of the 21st century”, and poses a serious problem relating to health and medical care of the people.

Impaired glucose tolerance, which is prediabetes, indicates a higher risk of incidence of diabetic complication due to development into diabetes in the future or cardiovascular disturbance due to arteriosclerosis. In recent years, due to lifestyle habits associated with high-fat diets and a lack of exercise, an increasing number of people have symptoms of metabolic syndrome, which is a combination of hyperglycemia, hypertension, and hyperlipidemia on the basis of obesity and insulin resistance. Such symptoms currently attract attention as an urgent issue of medical insurance because of an increase in the number of people who develop arteriosclerosis over time and finally have cardiovascular disturbances, such as myocardial infarction, or cerebrovascular accidents, such as cerebral infarction. Both diabetes and metabolic syndrome are caused by lifestyle habits and they are strongly correlated.

It is considered that the metabolism of amino acids is affected by peripheral tissues due to insulin resistance caused by the accumulation of visceral fat and is highly associated with glucose metabolism, lipid metabolism, inflammatory reaction, and redox regulatory mechanisms. Therefore, if an amino acid is found, which specifically varies in peripheral blood, or the like, due to impaired glucose tolerance, it is widely applicable as a simple and sensitive testing approach that reflects metabolic changes lying behind impaired glucose tolerance.

However, there have not been any reports on amino acid metabolic patterns in peripheral blood in the state of impaired glucose tolerance, and there have been only reports on changes of amino acids in obesity or diabetes (see the document “Felig, P., Marliss, E., et al., New Engl. J. Med. 281,811 (1969).” or the document “Felig, P., Marliss, E., et al., Diabetes, 19, 727 (1970)”).

According to the present invention, for example, evaluation of the state of impaired glucose tolerance (specifically, discrimination between the two groups: a impaired glucose tolerance group and a normal group) can be performed. Thus, evaluation of the state of impaired glucose tolerance (specifically, discrimination between the two groups: impaired glucose tolerance or normal) can be performed with high accuracy by using a BN model that includes amino acid concentrations in blood plasma as explanatory variables. In the present specification, impaired glucose tolerance and diabetes, for which the OGTT two-hour value from an oral glucose tolerance test (OGTT) is equal to or more than 140 mg/dl, according to classification by the American Diabetes Association in 1997 are referred to together as impaired glucose tolerance. Because impaired glucose tolerance includes symptoms of hyperglycemia on the basis of insulin resistance and a risk of cardiovascular disorder associated therewith, the present invention is useful for discrimination thereof.

According to the present invention, amino acid concentration data on the subject may be measured from blood that is collected from the subject to whom a desired substance group consisting of one or more substances has been administered, and it may be determined whether the desired substance group prevents impaired glucose tolerance or ameliorates the state of impaired glucose tolerance by using an evaluation result obtained in step S-2. Thus, a substance that prevents or ameliorates impaired glucose tolerance can be searched for with high accuracy by using a result of evaluation of the state of impaired glucose tolerance (specifically, discrimination between the two groups: impaired glucose tolerance or normal), which is performed by using a BN model that includes amino acid concentrations in blood plasma as explanatory variables.

The BN is a probability model in which a qualitative causal relation or dependency relation between random variables is represented by a graph structure and a quantitative dependency relation between the respective random variables is represented by conditional probability (see the document “Jensen, F. and Nielsen, T., Bayesian Networks and Decision Graphs, Springer, 2007.”). Therefore, the BN model is defined by a set of a plurality of explanatory variables necessary for representing the model, a graph structure that represents a qualitative dependency relation therebetween, and conditional probability that represents a quantitative dependency relation therebetween.

In the graph structure of the BN model, explanatory variables are illustrated as nodes and the dependency relation between the respective explanatory variables is illustrated by using a directed link that has a direction. The directed link is a line with an arrow connecting between nodes and is called an edge or arc. The entire graph structure is expressed by a noncyclic directed graph in which, when a path is connected via a link with an arrow starting from a node, there is no return to the original node. If the directed link A→B is present, the root node A of the directed link is referred to as a parent node and the node B to which the arrow is directed is referred to as a child node. Further, if the directed link A→B is present, probability distribution of the explanatory variable B depends on the value of the explanatory variable A and is expressed by conditional probability P(B|A). Because the node A is the parent node of the node B, the explanatory variable A may be expressed as Pₐ(B) and the conditional probability P(B|A) may be expressed as P(B|Pₐ(B)) and, if a plurality of parent nodes is present, all of the parent nodes may be expressed as Pₐ(B). For example, if the amino acid concentration in blood plasma varies depending on whether the biological state is a healthy state or a disease state, this dependency relation can be qualitatively represented by a graph using the biological state explanatory variable A, indicative of either a healthy state or a disease state, as a parent node and the amino acid explanatory variable B, indicative of the varying amino acid concentration, as a child node.

Conditional probability is calculated by using sample data. If nodes included in the entire graph structure of the BN model are determined as {X₁, X₂, . . . , Xₙ}, the dependency relation between a node Xⱼ and its parent node Pₐ(Xⱼ) is quantitatively expressed by conditional probability P(Xⱼ|Pₐ(Xⱼ)), and joint probability distribution P(X₁, X₂, . . . , Xₙ) of all random variables is expressed by P(X₁, X₂, . . . Xₙ)=π_{j=1, 2, . . . , n}P(Xⱼ|Pₐ (Xⱼ)). Probabilistic reasoning for the biological state explanatory variable indicative of either a healthy state or a disease state is performed by using a probabilistic reasoning algorithm on the basis of BN structure if the amino acid explanatory variable indicative of the amino acid concentration and other explanatory variables included in the BN model are defined. Exact calculation, the sampling method, the Loopy belief propagation method, the junction tree method, or the like, can be used as a probabilistic reasoning algorithm.

### 2. System Configuration

Herein, the configuration of the biological state-evaluating system (hereinafter referred to sometimes as the present system) will be described with reference to FIGS. 2 to 10. This system is merely one example, and the present invention is not limited thereto.

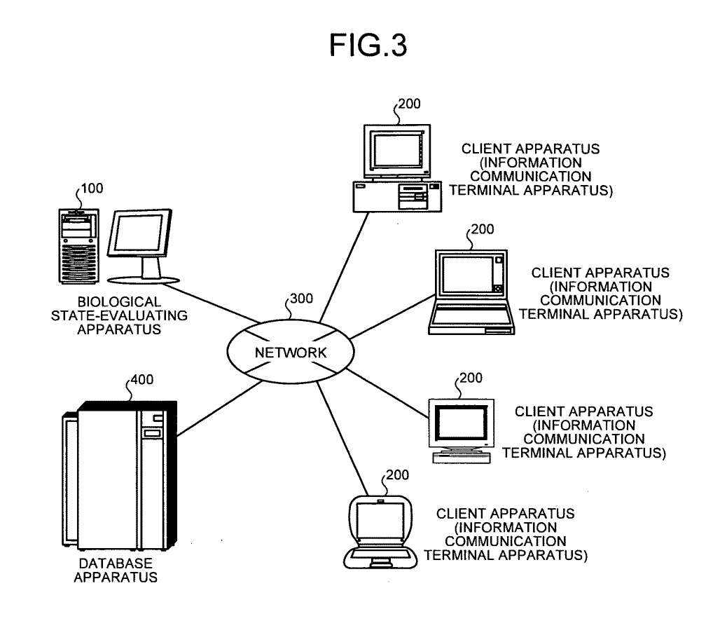

First, the entire configuration of the present system will be described with reference to FIGS. 2 and 3. FIG. 2 is a diagram showing an example of the entire configuration of the present system. FIG. 3 is a diagram showing another example of the entire configuration of the present system. As shown in FIG. 2, the present system is constituted by a biological state-evaluating apparatus 100 that evaluates the biological state of a subject to be evaluated and a client apparatus 200 (corresponding to the information communication terminal apparatus of the present invention) that provides the amino acid concentration data on the subject, both of which are communicatively connected to each other via a network 300.

In the present system as shown in FIG. 3, in addition to the biological state-evaluating apparatus 100 and the client apparatus 200, a database apparatus 400 storing amino acid concentration data for training and biological state data to be used for creating a BN model by the biological state-evaluating apparatus 100 may be communicatively connected via the network 300. Thus, information on a biological state, etc. is provided via the network 300 from the biological state-evaluating apparatus 100 to the client apparatus 200 and the database apparatus 400, or from the client apparatus 200 and the database apparatus 400 to the biological state-evaluating apparatus 100. The information on a biological state is information on the measured values of particular items of a biological state of organisms including humans. The information on a biological state is generated by the biological state-evaluating apparatus 100, the client apparatus 200, and other apparatuses (e.g., various measuring apparatuses) and stored mainly in the database apparatus 400.

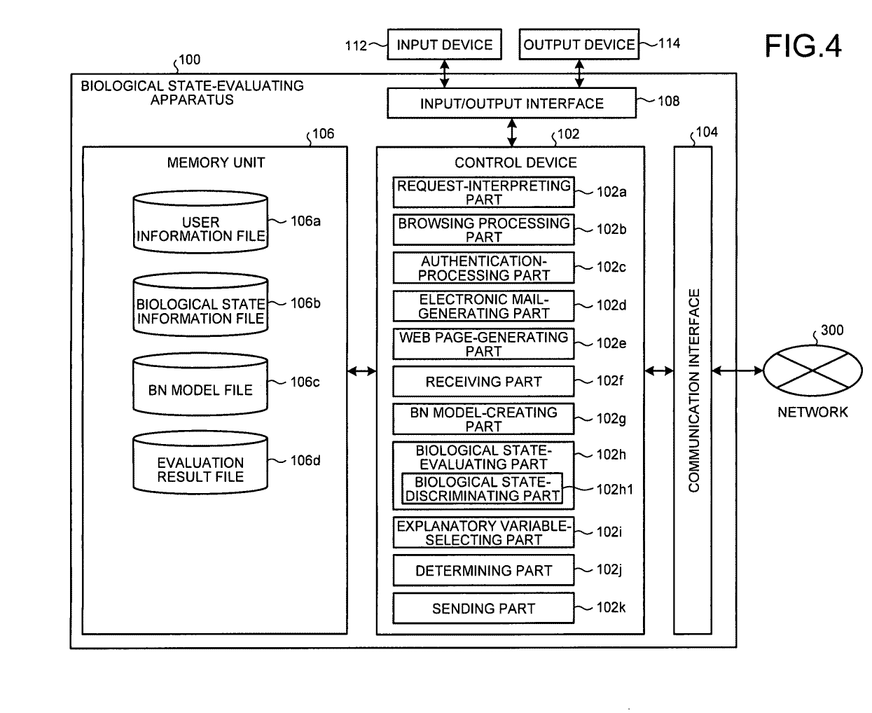

Now, the configuration of the biological state-evaluating apparatus 100 in the present system will be described with reference to FIGS. 4 to 8. FIG. 4 is a block diagram showing an example of the configuration of the biological state-evaluating apparatus 100 in the present system, showing conceptually only the part of the configuration relevant to the present invention.

The biological state-evaluating apparatus 100 is constituted by a control unit 102, such as CPU (Central Processing Unit), that integrally controls the biological state-evaluating apparatus, a communication interface 104 that connects the biological state-evaluating apparatus to the network 300 communicatively via a communication apparatus such as router and a wired or wireless communication line such as private line, a memory unit 106 that stores various databases, tables, files and others, and an input/output interface 108 connected to an input device 112 and an output device 114, that are connected to one another communicatively via any communication channel. The biological state-evaluating apparatus 100 may be contained in the same housing together with various analyzers (e.g., amino acid analyzer). Typical configuration of disintegration/integration of the biological state-evaluating apparatus 100 is not limited to that shown in the figure, and all or a part of it may be disintegrated or integrated functionally or physically in any unit according to various loads applied. For example, part of processing may be performed via a CGI (Common Gateway Interface).

The memory unit 106 is a storage means and, for example, memory apparatuses such as RAM (Random Access Memory) and ROM (Read Only Memory), fixed disk drives such as hard disks, flexible disks, optical disks, and the like can be used. The memory unit 106 stores computer programs for giving instructions to a CPU for various processing, together with an OS (Operating System). As shown in the figure, the memory unit 106 stores a user information file 106a, a biological state information file 106b, a BN model file 106c, and an evaluation result file 106d.

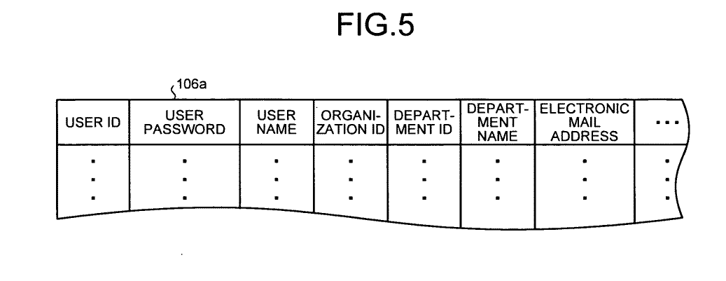

The user information file 106a stores user information on users. FIG. 5 is a chart showing an example of the information stored in the user information file 106a. As shown in FIG. 5, the information stored in the user information file 106a is constituted by user ID for identifying a user uniquely, user password for authentication as to whether the user is an authentic person, user name, organization ID for uniquely identifying the organization to which the user belongs, department ID for uniquely identifying the department of the organization to which the user belongs, department name, and electronic mail address of the user, which are associated to one another.

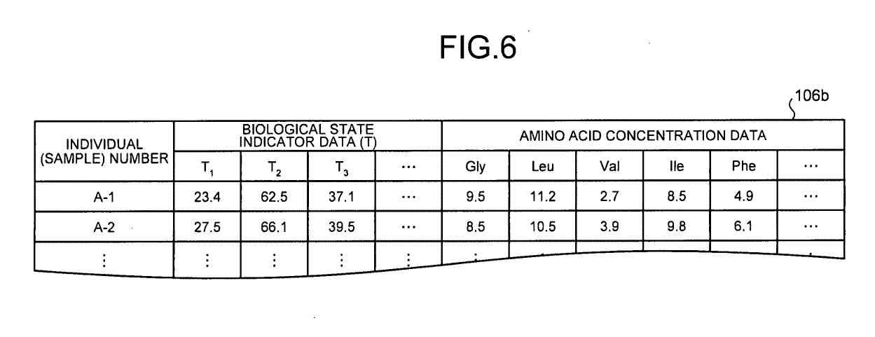

Refer back to FIG. 4. The biological state information file 106b stores biological state information to be used for creating a BN model. FIG. 6 is a chart showing an example of information stored in the biological state information file 106b. As shown in FIG. 6, the information stored in the biological state information file 106b includes an individual number, biological state indicator data (T) on an indicator (indicator T₁, indicator T₂, indicator T₃, . . . ) indicative of a biological state, and amino acid concentration data, which are correlated with one another. Although the biological state indicator data and the amino acid concentration data are expressed as numerical values (that is, on a continuous scale) in FIG. 6, the biological state indicator data and the amino acid concentration data may be expressed on a nominal scale or ordinal scale. In the case of the nominal scale or ordinal scale, any numerical value may be allocated to each state for analysis. The biological state indicator data is a known single state indicator that is a marker of a biological state and may be numerical data. Other than the amino acid concentration data and the biological state indicator data, other biological metabolites (for example, carbohydrate, lipid, protein, peptide, mineral, or hormone) or a biological indicator (for example, blood glucose level, blood-pressure level, sex, age, liver disease indicator, dietary habit, drinking habit, sport habit, degree of obesity, or disease history) may be combined.

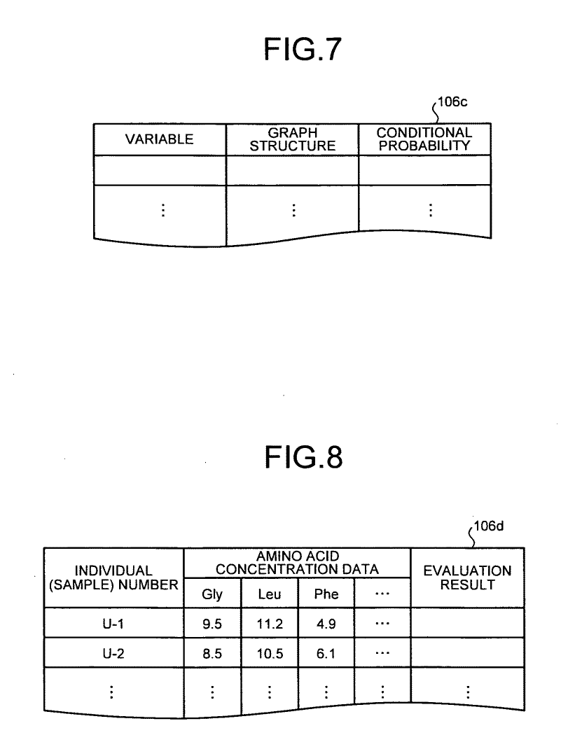

Refer back to FIG. 4. The BN model file 106c stores a BN model created by the BN model-creating part 102g described later. FIG. 7 is a chart showing an example of information stored in the BN model file 106c. As shown in FIG. 7, the information stored in the BN model file 106c includes explanatory variables corresponding to nodes of a BN (explanatory variables necessary for representing a BN model), a graph structure that represents a qualitative dependency relation therebetween (a graph structure that includes nodes and edges), and conditional probability that represents a quantitative dependency relation therebetween, which are correlated with one another.

Refer back to FIG. 4. The evaluation result file 106d stores an evaluation result obtained by the biological state-evaluating part 102h described later (specifically, a discrimination result obtained by a biological state-discriminating part 102h1 described later). FIG. 8 is a chart showing information stored in the evaluation result file 106d. The information stored in the evaluation result file 106d includes an individual number for uniquely identifying an individual (sample) that is a subject to be evaluated, previously obtained amino acid concentration data on the subject, and an evaluation result relating to biological state (specifically, discrimination result as to whether the biological state is a healthy state or a disease state), which are correlated with one another.

Refer back to FIG. 4. The memory unit 106 stores various Web data, CGI programs, and others for providing the client apparatus 200 with web site as information other than the information described above. The Web data includes various data for displaying Web pages described below and others, and the data is generated as, for example, a HTML or XML text file. Other temporary files such as files for components for generation of Web data and for operation, and others are also stored in the memory unit 106. The memory unit 106 may store as needed sound files of sound in the WAVE or AIFF format for transmission to the client apparatus 200 and image files of still image or motion picture in the JPEG or MPEG2 format.

The communication interface 104 allows communication between the biological state-evaluating apparatus 100 and the network 300 (or communication apparatus such as router). Thus, the communication interface 104 has a function to communicate data with a different terminal via a communication line.

The input/output interface 108 is connected to the input device 112 and the output device 114. A monitor (including home television), a speaker, or a printer can be used as the output device 114 (hereinafter, the output device 114 may be described sometimes as monitor 114). A keyboard, a mouse, a microphone, or a monitor functioning as a pointing device together with a mouse can be used as the input device 112.

The control unit 102 has an internal memory storing control programs such as an OS, programs defining various processing procedures, and other needed data and performs various types of information processing according to these programs. As shown in the figure, the control unit 102 primarily includes a request-interpreting part 102a, a browsing processing part 102b, an authentication-processing part 102c, an electronic mail-generating part 102d, a Web page-generating part 102e, a receiving part 102f, a BN model-creating part 102g, a biological state-evaluating part 102h, an explanatory variable-selecting part 102i, a determining part 102j, and a sending part 102k. The control unit 102 performs data processing, such as removal of data including defects, removal of data including many outliers, and removal of explanatory variables for defect-including data, on the biological state information transmitted from the database apparatus 400 and on the amino acid concentration data transmitted from the client apparatus 200.

The request-interpreting part 102a interprets contents of a request received from the client apparatus 200 or the database apparatus 400 and transfers processing to each part of the control unit 102 according to the analytical result. Upon receiving a browsing request for various screens from the client apparatus 200, the browsing processing part 102b generates and transmits the web data for these screens. Upon receiving an authentication request from the client apparatus 200 or the database apparatus 400, the authentication-processing part 102c performs authentication. The electronic mail-generating part 102d generates an electronic mail that includes various kinds of information. The Web page-generating part 102e generates a Web page for a user to browse with the client apparatus 200.

The receiving part 102f receives information (specifically, amino acid concentration data on a subject to be evaluated, biological state information for creating a BN model, or the like) transmitted from the client apparatus 200 or the database apparatus 400 via the network 300.

The BN model-creating part 102g performs the BN method by using the biological state information for creating a BN model received by the receiving part 102f, thereby creating a BN model that includes concentration values of amino acids and a numerical value indicative of the biological state as explanatory variables.

The biological state-evaluating part 102h evaluates the biological state (for example, the state of impaired glucose tolerance) of the subject by using the BN model created by the BN model-creating part 102g and using the amino acid concentration data on the subject received by the receiving part 102f. The biological state-evaluating part 102h further includes the biological state-discriminating part 102h1. The biological state-discriminating part 102h1 discriminates between a healthy state or a disease state of the biological state of the subject (for example, whether it is normal or impaired glucose tolerance) by using the BN model created by the BN model-creating part 102g and using the amino acid concentration data on the subject received by the receiving part 102f.

The explanatory variable-selecting part 102i selects, from the concentration values of the respective amino acids constituting the amino acid concentration data, the concentration values to be used as explanatory variables for performing the BN method by using a predetermined method. The predetermined method may be, for example, a multivariate analysis method or a search method of Bayesian network structure.

If the amino acid concentration data on the subject is measured from blood that is collected from the subject to whom a desired substance group consisting of one or more substances has been administered, the determining part 102j determines whether the desired substance group prevents impaired glucose tolerance or ameliorates the state of impaired glucose tolerance by using the evaluation result obtained by the biological state-evaluating part 102h.

The sending part 102k sends processing results of respective processing parts of the control unit 102 (the evaluation result obtained by the biological state-evaluating part 102h (specifically, the discrimination result obtained by the biological state-discriminating part 102h1), the determination result obtained by the determining part 102j, and the like) to the database apparatus 400 or the client apparatus 200 that has transmitted the amino acid concentration data on the subject.

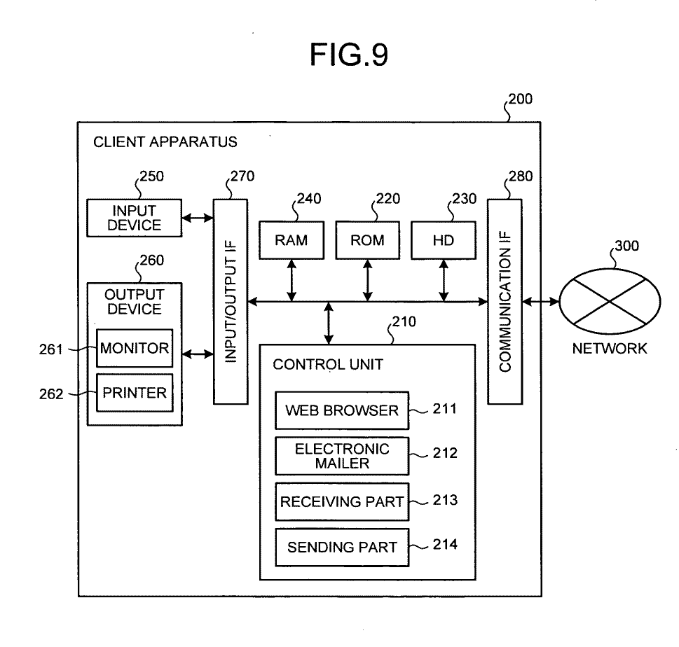

Hereinafter, the configuration of the client apparatus 200 in the present system will be described with reference to FIG. 9. FIG. 9 is a block diagram showing an example of the configuration of the client apparatus 200 in the present system, and only the part of the configuration relevant to the present invention is shown conceptually.

The client apparatus 200 is constituted by a control unit 210, a ROM 220, an HD 230, a RAM 240, an input device 250, an output device 260, an input/output IF 270, and a communication IF 280 that are connected communicatively to one another through any communication channel.

The control unit 210 includes a Web browser 211, an electronic mailer 212, a receiving part 213, and a sending part 214. The Web browser 211 performs browsing processing of interpreting Web data and displaying the interpreted Web data on a monitor 261 described below. The Web browser 211 may have various plug-in software, such as stream player, having functions to receive, display and feedback streaming screen image. The electronic mailer 212 sends and receives electronic mails using a particular protocol (e.g., SMTP (Simple Mail Transfer Protocol) or POP3 (Post Office Protocol version 3)). The receiving part 213 receives various information, such as evaluation results transmitted from the biological state-evaluating apparatus 100, via the communication IF 280. The sending part 214 sends various types of information such as amino acid concentration data on a subject to be evaluated to the biological state-evaluating apparatus 100 via the communication IF 280.

The input device 250 is a keyboard, a mouse, a microphone, or the like. The monitor 261 described below also functions as a pointing device together with a mouse. The output device 260 is an output means for outputting information received via the communication IF 280, and includes the monitor (including home television) 261 and a printer 262. In addition, the output device 260 may have a speaker or the like. The input/output IF 270 is connected to the input device 250 and the output device 260.

The communication IF 280 connects the client apparatus 200 to the network 300 (or communication apparatus such as router) communicatively. In other words, the client apparatus 200 is connected to the network 300 via a communication apparatus such as modem, TA, or router, and a telephone line, or a private line. Thus, the client apparatus 200 can access to the biological state-evaluating apparatus 100 by using a predetermined protocol.

The client apparatus 200 may be implemented by installing software (including programs, data and others) for Web data-browsing function and electronic mail-processing function to an information processing apparatus (for example, information processing terminal such as known personal computer, workstation, home-use game machine, Internet TV, PHS terminal, mobile phone terminal, mobile unit communication terminal, or PDA) that is connected as needed to peripheral devices such as printer, monitor, and image scanner.

All or any part of processing performed by the control unit 210 in the client apparatus 200 may be performed by a CPU and programs interpreted and executed by the CPU. Computer programs for giving instructions to the CPU and executing various processing together with the OS are recorded in the ROM 220 or the HD 230. The computer programs, which are executed by being loaded in the RAM 240, constitute the control unit 210 together with the CPU. The computer programs may be stored on an application program server connected to the client apparatus 200 via any network, and the client apparatus 200 may download all or a part of them as needed. All or any part of processing performed by the control unit 210 may be implemented by hardware such as wired-logic.

Hereinafter, the network 300 in the present system will be described with reference to FIGS. 2 and 3. The network 300 has a function to connect the biological state-evaluating apparatus 100, the client apparatus 200, and the database apparatus 400 mutually, communicatively to one another and is, for example, the Internet, intranet, or LAN (both wired/wireless). The network 300 may be VAN, personal computer communication network, public telephone network (including both analog and digital), leased line network (including both analog and digital), CATV network, portable switched network or portable packet-switched network (including IMT2000 system, GSM system, or PDC/PDC-P system), wireless calling network, local wireless network such as Bluetooth (registered trademark), PHS network, satellite communication network (including CS, BS, and ISDB), or the like.

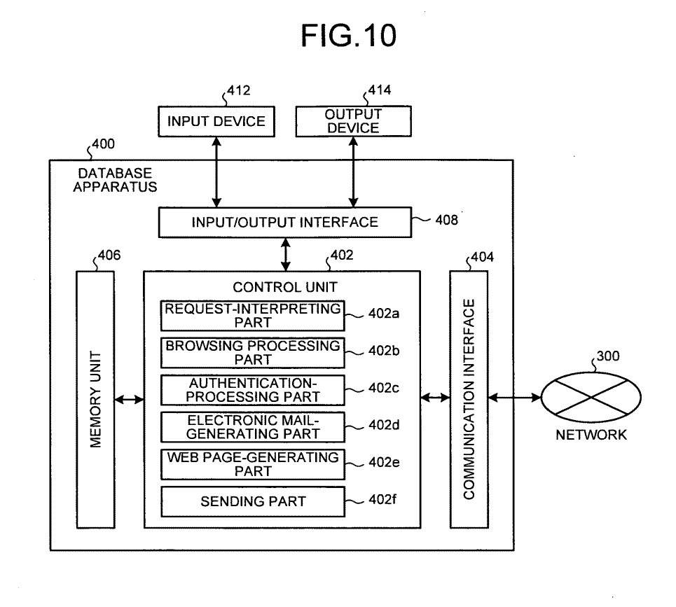

Hereinafter, the configuration of the database apparatus 400 in the present system will be described with reference to FIG. 10. FIG. 10 is a block diagram showing an example of the configuration of the database apparatus 400 in the present system, showing conceptually only the part of the configuration relevant to the present invention.

The database apparatus 400 has functions to store biological state information used for creating a BN model by the biological state-evaluating apparatus 100, a BN model created by the biological state-evaluating apparatus 100, an evaluation result or a determination result obtained by the biological state-evaluating apparatus 100, and the like. As shown in FIG. 10, the database apparatus 400 is constituted by a control unit 402, such as a CPU, that performs overall control of the database apparatus, a communication interface 404 that connects the database apparatus to the network 300 communicatively via a communication apparatus such as router and via a wired or wireless communication circuit such as private line, a memory unit 406 that stores various database, tables and files (for example, file for Web page), and an input/output interface 408 that is connected to an input device 412 and an output device 414, and these parts are connected communicatively to one another via any communication channel.

The memory unit 406 is a storage means and, for example, memory apparatus such as RAM or ROM, fixed disk drive such as hard disk, flexible disk, optical disk, or the like may be used. Various programs used for various types of processing, and the like, are stored in the memory unit 406. The communication interface 404 allows communication between the database apparatus 400 and the network 300 (or communication apparatus such as router). Thus, the communication interface 404 has a function to communicate data with a different terminal via a communication line. The input/output interface 408 is connected to the input device 412 and the output device 414. A monitor (including home television), a speaker, or a printer may be used as the output device 414 (hereinafter, the output device 414 may be sometimes described as the monitor 414). A keyboard, a mouse, a microphone, or a monitor functioning as a pointing device together with a mouse may be used as the input device 412.

The control unit 402 has an internal memory that stores control programs such as an OS, programs that define various processing procedures, needed data, and the like, and performs various information processing according to these programs. As shown in the figure, the control unit 402 primarily includes a request-interpreting part 402a, a browsing processing part 402b, an authentication-processing part 402c, an electronic mail-generating part 402d, a Web page-generating part 402e, and a sending part 402f.

The request-interpreting part 402a interprets the contents of a request received from the biological state-evaluating apparatus 100 and transfers processing to respective parts of the control unit 402 according to the analytical result. Upon receiving a browsing request for various screens from the biological state-evaluating apparatus 100, the browsing processing part 402b generates and transmits web data for these screens. Upon receipt of an authentication request from the biological state-evaluating apparatus 100, the authentication-processing part 402c performs authentication. The electronic mail-generating part 402d generates an electronic mail including various types of information. The Web page-generating part 402e generates a Web page for a user to browse with the client apparatus 200. The sending part 402f sends various types of information such as biological state information to the biological state-evaluating apparatus 100.

### 3. Processing of the Present System

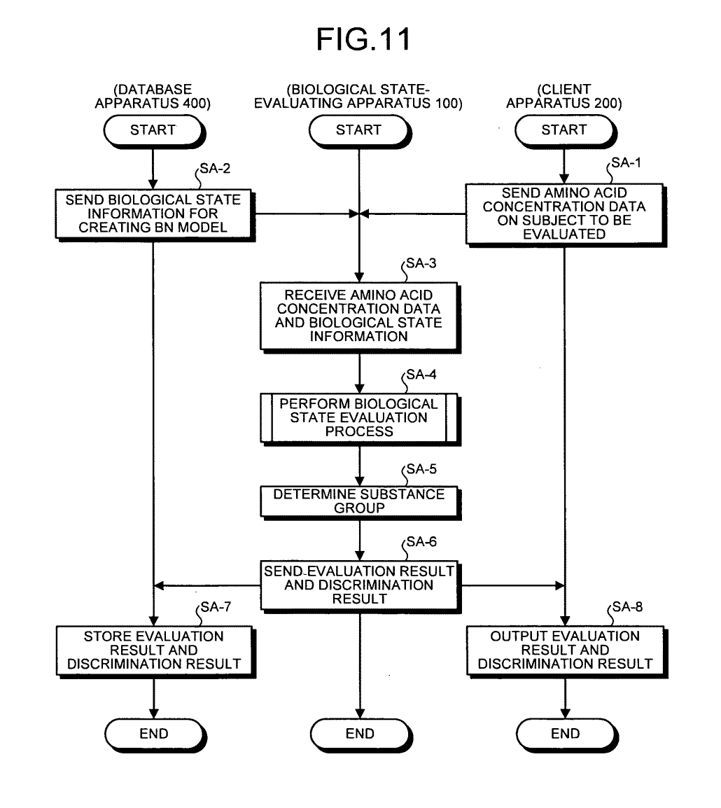

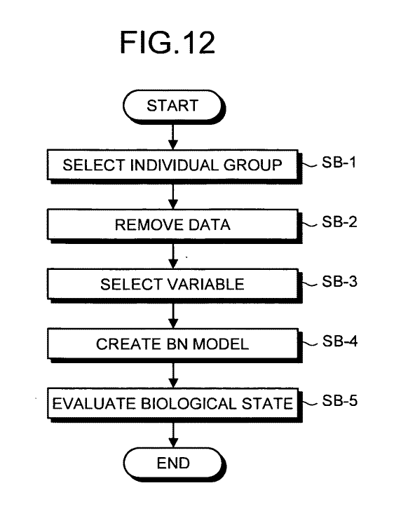

Next, an explanation is given of an example of processing performed by the present system configured as described above with reference to FIGS. 11 and 12.

### 3-1. Biological State Evaluation Service Process

Hereinafter, an explanation is given of an example of a biological state evaluation service process performed by the present system with reference to FIG. 11. FIG. 11 is a flowchart showing an example of the biological state evaluation service process.

The amino acid concentration data on the subject, which is used in the present process, is obtained by analyzing blood that is collected from the subject (for example, an individual such as an animal or a human) to whom a desired substance group consisting of one or more substances has been administered in advance. In the present process, the state of impaired glucose tolerance is evaluated and a substance that prevents or ameliorates impaired glucose tolerance is searched for.

For example, an appropriate combination of existing drugs, amino acids, food, and supplements that can be administered to humans (for example, an appropriate combination of drugs, supplements, anti-obesity drugs, and the like that are known to be effective in improving various symptoms of impaired glucose tolerance) may be administered for a predetermined period (for example, a range from one day to 12 months) in a predetermined quantity with a predetermined frequency or timing (for example, three times a day, after eating) by using a predetermined administration method (for example, oral administration). An administration method, dosage, or dosage form may be combined as appropriate depending on symptoms. The dosage form may be determined according to well-known technology. The dosage is not particularly specified and, for example, administration may be performed in the form such that 1 μg to 100 g of active ingredient is contained.

The concentration values of amino acids in blood may be measured as described below. First, a collected blood sample is put into a heparin-treated tube. Then, the blood plasma is separated from the blood by centrifugation of the blood sample in the tube. The separated blood plasma samples are frozen and stored at −70° C. before measurement of amino acid concentration. A frozen and stored blood plasma sample is unfrozen and then deproteinized by adding sulfosalicylic acid to the unfrozen blood plasma sample to a concentration of 3%. The deproteinized blood plasma sample is processed by an amino acid analyzer employing the principle of high-performance liquid chromatography (HPLC) using a ninhydrin reaction in the post column so as to measure the concentrations values of various amino acids.

First, the client apparatus 200 accesses the biological state-evaluating apparatus 100 when the user specifies a Web site address (such as URL) provided by the biological state-evaluating apparatus 100 via the input device 250 on the screen displaying the Web browser 211. Specifically, when the user instructs update of the Web browser 211 screen on the client apparatus 200, the Web browser 211 transmits the Web site address provided by the biological state-evaluating apparatus 100 to the biological state-evaluating apparatus 100 by using a predetermined protocol, thereby issuing a request demanding transmission of the Web page corresponding to the amino acid concentration data transmission screen to the biological state-evaluating apparatus 100 based on the routing of the address.

Then, upon receipt of the request from the client apparatus 200, the request-interpreting part 102a in the biological state-evaluating apparatus 100 analyzes the contents of the transmitted request and sends processing to other parts in the control unit 102 according to the analytical result. Specifically, when the contents of the transmitted request is a request to transmit the Web page corresponding to the amino acid concentration data transmission screen, mainly the browsing processing part 102b in the biological state-evaluating apparatus 100 obtains the Web data for display of the Web page stored in a predetermined memory region of the memory unit 106 and transmits the obtained Web data to the client apparatus 200. More specifically, upon receiving the Web page transmission request corresponding to the amino acid concentration data transmission screen from the user, the control unit 102 in the biological state-evaluating apparatus 100 demands input of user ID and user password from the user. If the user ID and password are input, the authentication-processing part 102c in the biological state-evaluating apparatus 100 performs authentication by using the input user ID and password and the user ID and user password stored in the user information file 106a. Only when the user is authentic, the browsing processing part 102b in the biological state-evaluating apparatus 100 transmits, to the client apparatus 200, the Web data for displaying the Web page corresponding to the amino acid concentration data transmission screen. The client apparatus 200 is identified by using the IP address transmitted from the client apparatus 200 together with the transmission request.

Then, the receiving part 213 in the client apparatus 200 receives the Web data (for displaying the Web page corresponding to the amino acid concentration data transmission screen) transmitted from the biological state-evaluating apparatus 100, interprets the received Web data with the Web browser 211, and displays the amino acid concentration data transmission screen on the monitor 261.

When the user inputs and selects, via the input device 250, the amino acid concentration data on a subject to be evaluated, or the like, on the amino acid concentration data transmission screen displayed on the monitor 261, the sending part 214 in the client apparatus 200 sends an identifier for identifying input information and selected items to the biological state-evaluating apparatus 100, thereby transmitting the amino acid concentration data on the subject to the biological state-evaluating apparatus 100 (step SA-1). In step SA-1, transmission of the amino acid concentration data may be performed by using an existing file transfer technology such as FTP.

Then, the request-interpreting part 102a in the biological state-evaluating apparatus 100 interprets the identifier transmitted from the client apparatus 200, thereby analyzing the contents of the request received from the client apparatus 200, and issues, to the database apparatus 400, a request for transmission of biological state information for creating a BN model.

Then, the request-interpreting part 402a in the database apparatus 400 interprets the transmission request received from the biological state-evaluating apparatus 100 and transmits biological state information (for example, updated biological state information) for creating a BN model, which is stored in a predetermined memory region of the memory unit 406, to the biological state-evaluating apparatus 100 (step SA-2).

The receiving part 102f in the biological state-evaluating apparatus 100 then receives the amino acid concentration data on the subject, which is transmitted from the client apparatus 200, and the biological state information for creating a BN model, which is transmitted from the database apparatus 400 (step SA-3).

The control unit 102 in the biological state-evaluating apparatus 100 then performs 3-2. Biological State Evaluation Process described later (step SA-4).

The determining part 102j in the biological state-evaluating apparatus 100 then determines whether a desired substance group, which has been administered to the subject in advance, prevents impaired glucose tolerance or ameliorates the state of impaired glucose tolerance by using an evaluation result (an evaluation result relating to the state of impaired glucose tolerance) obtained in step SA-4 (step SA-5). If the determination result obtained in step SA-5 indicates that “it is prevented or ameliorated”, the desired substance group administered to the subject is searched for as the one that prevents impaired glucose tolerance or ameliorates the state of impaired glucose tolerance. Searching for a substance group that prevents or ameliorates impaired glucose tolerance includes not only finding a new substance effective in preventing or ameliorating impaired glucose tolerance but also finding new uses for a known substance for preventing or ameliorating impaired glucose tolerance, finding a new composition obtained by combining existing drugs, supplements, and the like that is expected to be effective in preventing or ameliorating impaired glucose tolerance, finding appropriate usage, dosage, and combinations of what is described above so as to provide kits, presenting a prophylactic and therapeutic menu including diet and physical activity, and the like, and monitoring effects of the prophylactic and therapeutic menu so as to propose changes in the menu for individuals as needed, or the like.

The sending part 102k in the biological state-evaluating apparatus 100 then sends the evaluation result obtained in step SA-4 and the determination result obtained in step SA-5 to the client apparatus 200 that has transmitted the amino acid concentration data on the subject and to the database apparatus 400 (step SA-6). Specifically, the Web page-generating part 102e in the biological state-evaluating apparatus 100 first generates a Web page for displaying the evaluation result and the determination result and stores the Web data corresponding to the generated Web page in a predetermined memory region of the memory unit 106. Then, after the user is authenticated as described above by inputting a predetermined URL into the Web browser 211 of the client apparatus 200 via the input device 250, the client apparatus 200 transmits a Web page browsing request to the biological state-evaluating apparatus 100. The browsing processing part 102b in the biological state-evaluating apparatus 100 then interprets the browsing request transmitted from the client apparatus 200 and reads the Web data corresponding to the Web page for displaying the evaluation result and the determination result from the predetermined memory region of the memory unit 106. The sending part 102m in the biological state-evaluating apparatus 100 then sends the read Web data to the client apparatus 200 and sends the Web data or the evaluation result and the determination result to the database apparatus 400.

In step SA-6, the control unit 102 in the biological state-evaluating apparatus 100 may notify the user's client apparatus 200 of the evaluation result and the determination result by electronic mail. Specifically, the electronic mail-generating part 102d in the biological state-evaluating apparatus 100 first acquires the user's electronic mail address by referring to the user information stored in the user information file 106a on the basis of the user ID, or the like, in accordance with the transmission timing. The electronic mail-generating part 102d in the biological state-evaluating apparatus 100 then generates electronic mail data including the user name, the evaluation result, and the determination result using the obtained electronic mail address as its mail address. The sending part 102m in the biological state-evaluating apparatus 100 then sends the generated data to the user's client apparatus 200.

Also in step SA-6, the biological state-evaluating apparatus 100 may transmit the discrimination result to the user's client apparatus 200 by using an existing file transfer technology such as FTP.

Refer back to the descriptions of FIG. 11. The control unit 402 in the database apparatus 400 receives the evaluation result and the determination result or the Web data transmitted from the biological state-evaluating apparatus 100 and stores (accumulates) the received evaluation result and the discrimination result or the Web data in a predetermined memory region of the memory unit 406 (step SA-7).

The receiving part 213 in the client apparatus 200 receives the Web data transmitted from the biological state-evaluating apparatus 100, and the received Web data is interpreted by the Web browser 211 in order to display on the monitor 261 the Web page screen displaying the evaluation result and the determination result of the subject (step SA-8). When the evaluation result and the determination result are transmitted from the biological state-evaluating apparatus 100 by electronic mail, the electronic mail transmitted from the biological state-evaluating apparatus 100 is received at a given time, and the received electronic mail is displayed on the monitor 261 by using the known function of the electronic mailer 212 in the client apparatus 200.

As described above, the user browses the Web page displayed on the monitor 261 so as to check the evaluation result relating to the state of impaired glucose tolerance and the determination result as to whether a desired substance group, which is administered to the subject, prevents or ameliorates impaired glucose tolerance. The user can print out the content of the Web page displayed on the monitor 261 by using the printer 262.

If the evaluation result and the determination result are transmitted by electronic mail from the biological state-evaluating apparatus 100, the user browses the electronic mail displayed on the monitor 261 so as to check the evaluation result and the determination result. The user may print out the contents of the electronic mail displayed on the monitor 261 by using the printer 262.

Here, the explanation of the biological state evaluation service process is finished.

### 3-2. Biological State Evaluation Process

Hereinafter, a detailed explanation is given of an example of a biological state evaluation process performed by the biological state-evaluating apparatus 100 with reference to FIG. 12. FIG. 12 is a flowchart showing an example of the biological state evaluation process performed by the biological state-evaluating apparatus 100.

First, the control unit 102 in the biological state-evaluating apparatus 100 selects an individual (sample) group to be used for creating a BN model from the biological state information received in step SA-3 (step SB-1).

The control unit 102 in the biological state-evaluating apparatus 100 then removes data (data including defects or many outliers, or the like) that is undesirable for creating a BN model from the biological state information on the individual selected in step SB-1 (step SB-2).

The explanatory variable-selecting part 102i in the biological state-evaluating apparatus 100 then selects, from the concentration values of respective amino acids constituting amino acid concentration data contained in the biological state information from which the undesirable data has been removed in step SB-2, concentration values to be used as explanatory variable for performing the BN method by using a predetermined method (step SB-3).

In step SB-3, the explanatory variable-selecting part 102i may select an amino acid to be used as an explanatory variable for performing the BN method by using a multivariate analysis method. Specifically, the explanatory variable-selecting part 102i may select an amino acid explanatory variable included in an evaluation formula generated by a method disclosed in International Publication WO 2006/098192. Specifically, the explanatory variable-selecting part 102i may select an amino acid explanatory variable included in a logistic regression equation generated by the stepwise method.

In step SB-3, the explanatory variable-selecting part 102i may select an amino acid to be used as an explanatory variable for performing the BN method by using a search method of BN structure. Specifically, a graph structure that includes a candidate explanatory variable is searched for by using, for example, an exhaustive search method or a K2 algorithm using a greedy algorithm so that the network structure of a BN that reflects a qualitative causal relation or dependency relation between explanatory variables is obtained with an optimal evaluation index (for example, AIC (Akaike Information Criterion), BIC (Bayesian Information Criterion), or MDL (Minimum Description Length)) determined depending on the structure, and an amino acid explanatory variable included in the obtained optimal network structure may be selected.

The BN model-creating part 102g in the biological state-evaluating apparatus 100 then performs the BN method by using the biological state information that includes the concentration values of amino acids selected in step SB-3, thereby creating a BN model that includes the concentration values of amino acids selected in step SB-3 and the numerical value indicative of the biological state as explanatory variables (step SB-4).

The biological state-evaluating part 102h in the biological state-evaluating apparatus 100 then evaluates the biological state (for example, the state of impaired glucose tolerance) of the subject by using the BN model created in step SB-4 and the amino acid concentration data on the subject and then stores the evaluation result in a predetermined memory region of the evaluation result file 106d (step SB-5). Specifically, the biological state-discriminating part 102h1 in the biological state-evaluating apparatus 100 discriminates between a healthy state or a disease state of the biological state of the subject (for example, as to whether the subject is impaired glucose tolerance or normal) by using the BN model created in step SB-4 and the amino acid concentration data on the subject and then stores the discrimination result in a predetermined memory region of the evaluation result file 106d.

Here, an explanation of the biological state evaluation process is finished.

### 4. Summary of the Present Embodiment and Other Embodiments

As described above in detail, according to the present system, the client apparatus 200 transmits the amino acid concentration data on the subject to the biological state-evaluating apparatus 100, and the database apparatus 400 transmits the biological state information for creating a BN model to the biological state-evaluating apparatus 100 upon receipt of a request from the biological state-evaluating apparatus 100. The biological state-evaluating apparatus 100 receives the amino acid concentration data on the subject from the client apparatus 200, receives the biological state information for creating a BN model from the database apparatus 400, creates a BN model by using the received biological state information, evaluates the state of impaired glucose tolerance of the subject (performs discrimination as to whether the subject is normal or impaired glucose tolerance) by using the created BN model and the received amino acid concentration data, determines whether a substance group, which has been administered to the subject in advance, prevents or ameliorates impaired glucose tolerance in accordance with the evaluation result (discrimination result), and transmits the evaluation result and the determination result to the client apparatus 200 and the database apparatus 400. The client apparatus 200 then receives and displays the evaluation result and the determination result transmitted from the biological state-evaluating apparatus 100, and the database apparatus 400 receives and stores the evaluation result and the determination result transmitted from the biological state-evaluating apparatus 100. Thus, impaired glucose tolerance can be evaluated with high accuracy by using a BN model that includes amino acid concentrations in blood plasma as explanatory variables.

According to the present system, concentration values to be used as explanatory variables for performing the BN method may be selected from concentration values of respective amino acids constituting amino acid concentration data by using a predetermined method. Thus, amino acids in blood plasma, which have a significant dependency relation with impaired glucose tolerance, can be selected and, as a result, impaired glucose tolerance can be evaluated with higher accuracy. That is, evaluation performance of impaired glucose tolerance using a BN can be improved.

Further, according to the present system, the predetermined method may be, for example, a multivariate analysis method or a search method of Bayesian network structure. Thus, amino acids in blood plasma, which have a significant dependency relation with impaired glucose tolerance, can be efficiently selected by using an existing method and, as a result, impaired glucose tolerance can be evaluated with higher accuracy.

According to the present system, discrimination may be performed as to whether the subject is impaired glucose tolerance or normal by using the created BN model and the amino acid concentration data on the subject. Thus, discrimination of the two groups as to whether it is impaired glucose tolerance or normal can be performed with high accuracy by using a BN model that includes amino acid concentrations in blood plasma as explanatory variables.

According to the present system, the amino acid concentration data on the subject may be measured from blood that is collected from the subject to whom a desired substance group consisting of one or more substances is administered and, in accordance with the evaluation result obtained in step SA-4, it may be determined whether the desired substance group prevents impaired glucose tolerance or ameliorates the state of impaired glucose tolerance. Thus, a substance that prevents or ameliorates impaired glucose tolerance can be searched for with high accuracy by using a result of evaluation of the state of impaired glucose tolerance (specifically, discrimination between the two groups: impaired glucose tolerance or normal), which is performed by using a BN model that includes amino acid concentrations in blood plasma as explanatory variables.

In addition to the embodiments described above, the biological state-evaluating apparatus, the biological state-evaluating method, the biological state-evaluating system, the biological state-evaluating program, and the recording medium according to the present invention can be practiced in various different embodiments within the technological scope of the descriptions in the documents of the claims. For example, among respective processes described in the embodiments described above, all or part of the processing performed automatically as described above may be performed manually, and all or part of the processing performed manually as described above may be performed automatically by known methods. In addition, processing procedure, control procedure, specific name, various registered data, information including parameters such as retrieval condition, screen, and database configuration shown in the description above or drawings may be modified arbitrarily, unless specified otherwise. For example, the components of the biological state-evaluating apparatus 100 shown in the figures are conceptual and functional and may not be configured physically as shown in the figure. In addition, all or any part of the operational function of each component and each device in the biological state-evaluating apparatus 100 (in particular, each operational function performed by the control unit 102) may be executed by the CPU (Central Processing Unit) or the programs interpreted and executed by the CPU, and may be implemented as wired-logic hardware.

The “program” is a data processing method written in any language or by any description method and may be of any format such as source code or binary code. The “program” may not be configured singly and may be configured separately as a plurality of modules or libraries or operated together with a different program such as an OS (Operating System) to perform the function. The program is stored on a recording medium and read mechanically by the biological state-evaluating apparatus 100 as needed. Any well-known configuration or procedure may be used for a specific configuration or procedure for reading the programs recorded on the recording medium in each apparatus and a procedure for installation after reading.

The “recording media” includes any “portable physical media”, “fixed physical media”, and “communication media”. The “portable physical media” includes flexible disk, magnetic optical disk, ROM, EPROM, EEPROM, CD-ROM, MO, DVD, and the like. The “fixed physical media” includes ROM, RAM, HD, or the like, installed in various computer systems. The “communication media” stores the program for a short period of time such as communication line and carrier wave when the program is transmitted via a network such as LAN, WAN, or the Internet.

### Example 1

According to the joint diagnostic criteria of the Japanese Society of Internal Medicine-associated eight academic societies, 205 examinees who underwent comprehensive medical examination were divided into a non-metabolic syndrome group (173 examinees) and a metabolic syndrome group (32 examinees), and the concentrations of amino acids in blood were measured from respective blood samples by the above-described amino acid analysis method. The 205 examinees did not include those who were under treatment for diseases such as hypertension or diabetes. An index for maximizing discrimination performance between the two groups, i.e., the non-metabolic syndrome group and the metabolic syndrome group, was searched for by using a search method for a multivariate discriminant disclosed in International Publication WO 2006/098192. Logistic analysis using the stepwise method was used as an example of a search for a multivariate discriminant so that a logistic regression equation composed of Ala and Gly was obtained as an index formula (the numerical coefficients and constant terms of the amino acid explanatory variables Ala and Gly were 0.013±0.003, −0.029±0.008, −0.540±1.890 in the same order). Diagnostic performance (discrimination performance) between two groups using this index formula was evaluated by using the AUC of the ROC curve to obtain an AUC of 0.798 (95% confidence interval: 0.726 to 0.870).

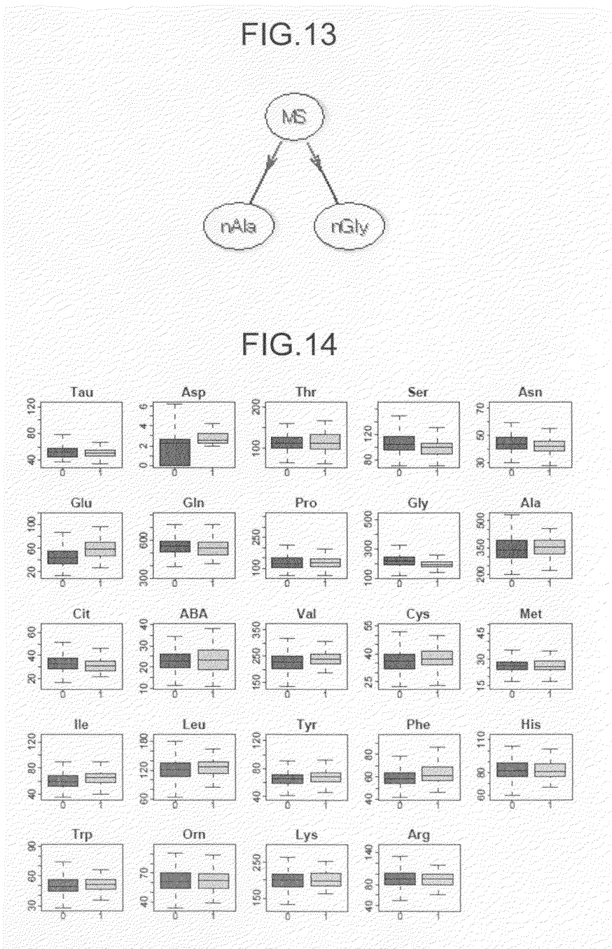

Then, a BN is created that includes explanatory variables Ala and Gly obtained as described above and a state explanatory variable MS that indicates the two states of non-metabolic syndrome and metabolic syndrome (non-metabolic syndrome: 0, metabolic syndrome: 1) (see FIG. 13). Two nodes, nAla and nGly, in FIG. 13 represent discrete variables obtained by discretizing the explanatory variables Ala and Gly, and the node MS represents the state explanatory variable that indicates the two states: non-metabolic syndrome and metabolic syndrome. The same sample data as that described above was used to compute a conditional probability table. According to Bayes' theorem using the BN method of FIG. 13, the estimated probability of the state explanatory variable MS was obtained with respect to Ala and Gly for each sample. The diagnostic performance (discrimination performance) between the two groups, for which probability Pr(MS=1|Ala,Gly) with the state explanatory variable value of MS=1 was an index, was evaluated by using the AUC of the ROC curve to obtain an AUC of 0.826 (95% confidence interval: 0.762 to 0.889). Thus, it is proved that the estimated probability Pr(MS=1|Ala,Gly) using the BN method is a useful index having higher diagnostic performance than the above-described logistic regression equation.

### Example 2

Out of examinees who underwent an oral glucose tolerance test (OGTT) in a comprehensive medical examination, 304 examinees who had a fasting plasma glucose (FPG) level of less than 110 mg/dl were divided into a normal group (less than 140 mg/dl, 248 examinees) and a impaired glucose tolerance group (equal to or more than 140 mg/dl, 56 examinees) in accordance with the blood glucose level after two hours of OGTT on the basis of the above-described diagnostic criteria, and the concentrations of amino acids in their blood were measured from respective blood samples by the amino acid analysis method described above. The 304 examinees did not include those who were under treatment for diseases such as hypertension or hyperlipidemia. FIG. 14 is a boxplot showing the distribution of amino acid explanatory variables in the two groups: normal and impaired glucose tolerance. In FIG. 14, the horizontal axis indicates the normal group “0” and the impaired glucose tolerance group “1”, and ABA, Cys and Cit represent α-aminobutyric acid, Cystine and Citrulline, respectively. Welch's t-test was performed on the two groups for the purpose of discriminating between the two groups. In the impaired glucose tolerance group, when compared with the normal group, Glu, Ile, Val, Leu, Phe, and Asp significantly increased (significant probability P<0.05), and Gly and Ser significantly reduced, whereby it is proved that the amino acid explanatory variables Glu, Gly, Ser, Ile, Val, Leu, Phe, and Asp have an ability to discriminate between the two groups.

An index for maximizing discrimination performance between the two groups, impaired glucose tolerance and normal, was searched for by using a search method for a multivariate discriminant disclosed in International Publication WO 2006/098192. Logistic analysis using the stepwise method was used as an example of a search for a multivariate discriminant so that a logistic regression equation composed of Glu and Gly was obtained as an index formula (the numerical coefficients and constant terms of the amino acid explanatory variables Glu and Gly were 0.039±0.010, −0.013±0.005, −0.788±1.187 in the same order). Diagnostic performance (discrimination performance) between the two groups by using this index formula was evaluated by using the AUC of the ROC curve to obtain an AUC of 0.755 (95% confidence interval: 0.688 to 0.823).

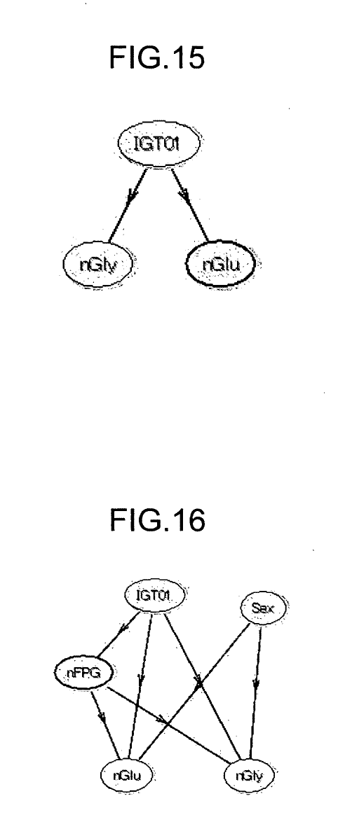

Then, a BN is created that includes explanatory variables Glu and Gly obtained as described above and a state explanatory variable IGT01 that indicates the two states: normal and impaired glucose tolerance (normal: 0, impaired glucose tolerance: 1) (see FIG. 15). Two nodes, nGlu and nGly, in FIG. 15 represent discrete variables obtained by discretizing the explanatory variables Glu and Gly, and the node IGT01 represents a state explanatory variable that indicates two states: impaired glucose tolerance and normal. The same sample data as that described above was used to compute a conditional probability table. According to Bayes' theorem using the BN method of FIG. 15, the estimated probability of the state explanatory variable IGT01 was obtained with respect to Glu and Gly for each sample. The diagnostic performance (discrimination performance) between two groups, for which probability Pr(IGT01=1|Glu,Gly) with the state explanatory variable value of IGT01=1 was an index, was evaluated by using the AUC of the ROC curve to obtain an AUC of 0.757 (95% confidence interval: 0.689 to 0.826). Thus, it is proved that the estimated probability Pr(IGT01=1|Glu,Gly) using the BN method is a useful index having diagnostic performance equal to or higher than the above-described logistic regression equation.

### Example 3

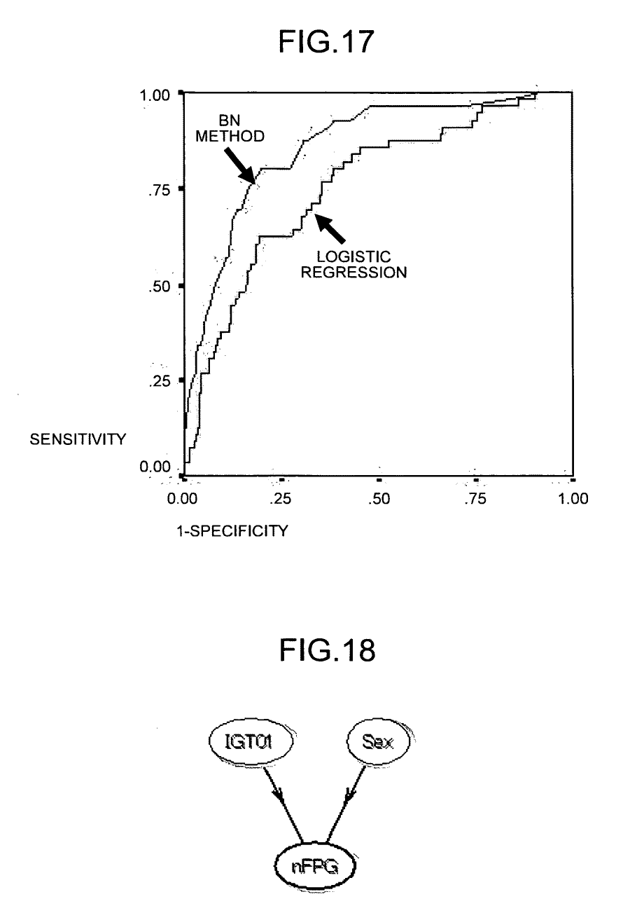

The sample data used in Example 2 was used. In addition to the explanatory variables Glu, Gly, and IGT01 (normal: 0, impaired glucose tolerance: 1) used in Example 2, a BN is created that includes a sex explanatory variable Sex (which is represented by a node Sex with two states of “1” for men and “2” for women) and a fasting plasma glucose level explanatory variable FPG (which is represented by a node nFPG obtained by discretizing FPG) (FIG. 16). In FIG. 16, the dependency relation between the sex and the amino acid explanatory variable and the dependency relation among the fasting plasma glucose level, IGT01, and the amino acid explanatory variable are further considered in addition to FIG. 15. For comparison, logistic regression analysis using five explanatory variables {Glu, Gly, IGT01, FPG, Sex} was also performed. According to Bayes' theorem using the BN method of FIG. 16, the estimated probability of the state explanatory variable IGT01 was obtained. The diagnostic performance (discrimination performance) between the two groups, for which probability Pr(IGT01=1|Glu,Gly,FPG,Sex) with the state explanatory variable value of IGT01=1 was an index, was evaluated by using the AUC of the ROC curve to obtain an AUC of 0.859 (95% confidence interval: 0.806 to 0.912). On the other hand, the diagnostic performance (discrimination performance) between the two groups using logistic regression was evaluated by using the AUC of the ROC curve to obtain an AUC of 0.772 (95% confidence interval: 0.707 to 0.838). Thus, it is proved that the estimated probability Pr(IGT01=1|Glu,Gly,FPG,Sex) using the BN method is a useful index having diagnostic performance equal to or higher than the above-described logistic regression equation. FIG. 17 shows comparison of ROC curves thereof.

To see the effects of the amino acid explanatory variables, the estimated probability of the state explanatory variable IGT01 was obtained with respect to BN structure (FIG. 18) that includes three explanatory variables {IGT01, FPG, Sex} that are obtained by removing the amino acid explanatory variables from the five explanatory variables. The diagnostic performance (discrimination performance) between the two groups, for which probability with the state explanatory variable value of IGT01=1 was an index, was evaluated by using the AUC of the ROC curve to obtain an AUC of 0.689 (95% confidence interval: 0.617 to 0.761). Thus, it largely decreases compared to FIG. 16, in which the amino acid explanatory variables were added, and it is indicated that the contribution of the amino acid explanatory variables is significant. This indicates that the amino acid explanatory variables can usefully be used as an evaluation method for the biological state using a BN.

### Example 4

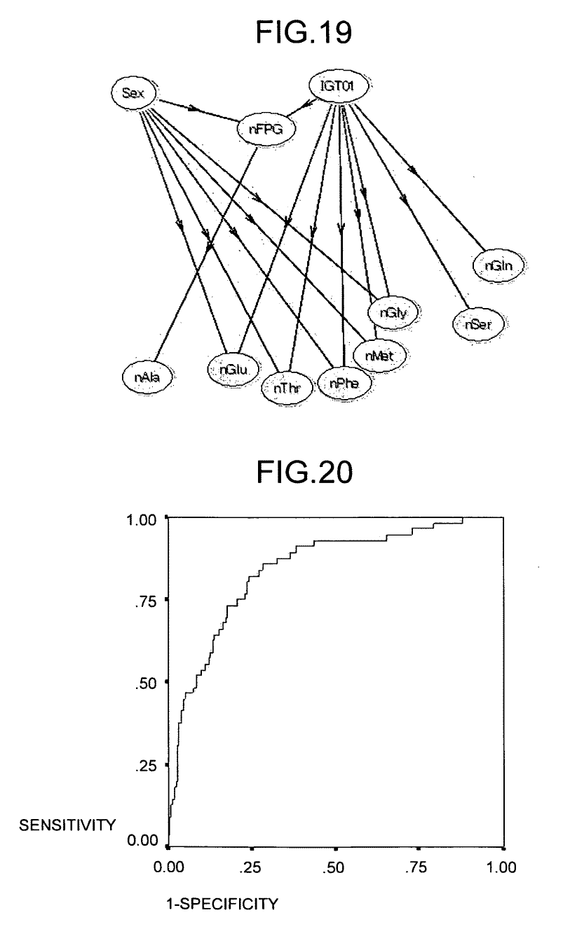

The sample data used in Example 2 was used. In addition to the five explanatory variables {Glu, Gly, IGT01, FPG, Sex} used in Example 3 of FIG. 16, amino acid explanatory variables {Val, Ile, Tyr, Orn, Pro, Trp, Lys, Leu, Asn, His, Tau, Ala, Thr, Phe, Met, Ser, Gln, Cys, Arg, Cit, ABA} and other explanatory variable, age {Age}, were used as candidate explanatory variables. Commercially available software “BayoNet (developed by the National Institute of Advanced Industrial Science and Technology:http://staff.aist.go.jp/y.motomura/bayonet/index J.html)” was used for a search for BN structure having a significant dependency relation between explanatory variables. A greedy search was specified as a search for BN structure, and AIC was specified as information criterion. FIG. 19 shows optimal BN structure obtained by the BN structure search. Explanatory variables, which were considered as candidate explanatory variables but are not shown in FIG. 19, form a network separated from the BN structure of FIG. 19 and are removed. In FIG. 19, amino acid explanatory variables {Glu, Gly, Ala, Thr, Phe, Met, Ser, Gln} are provided as nodes, and other explanatory variables {IGT01, Sex, FPG} are provided as nodes. The amino acid explanatory variables and the fasting plasma glucose level FPG, which were continuous variables, were used after being converted into discrete variables.

According to Bayes' theorem using the BN method of FIG. 19, the estimated probability of the state explanatory variable IGT01 was obtained. The diagnostic performance (discrimination performance) between the two groups, for which probability Pr(IGT01=1|Glu,Gly,Ala,Thr,Phe,Met,Ser,Gln,FPG,Sex) with the state explanatory variable value of IGT01=1 was an index, was evaluated by using the AUC of the ROC curve to obtain an AUC of 0.842 (95% confidence interval: 0.784 to 0.900). Thus, it is proved that the estimated probability Pr(IGT01=1|Glu,Gly,Ala,Thr,Phe,Met,Ser,Gln,FPG,Sex) using the BN method is a useful index having high discrimination performance. FIG. 20 indicates the ROC curve with respect to the BN represented in FIG. 19.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A biological state-evaluating apparatus comprising a control unit to evaluate a biological state of a subject to be evaluated, wherein the control unit includes:
a model creating unit that creates, by performing a Bayesian network method by using previously obtained amino acid concentration data on a concentration value of an amino acid and previously obtained biological state data on a numerical value indicative of the biological state, a Bayesian network model that includes, as the explanatory variables, the concentration value of the amino acid and the numerical value indicative of the biological state; and
a biological state-evaluating unit that evaluates the biological state of the subject by using the Bayesian network model created by the model creating unit and the previously obtained amino acid concentration data on the subject.

2. The biological state-evaluating apparatus according to claim 1, wherein the control unit further includes an explanatory variable-selecting unit that selects, from the concentration values of the respective amino acids constituting the amino acid concentration data, a concentration value to be used as the explanatory variable for performing the Bayesian network method by a predetermined method.

3. The biological state-evaluating apparatus according to claim 2, wherein the predetermined method is a multivariate analysis method or a search method of Bayesian network structure.

4. The biological state-evaluating apparatus according to claim 1, wherein the Bayesian network model further includes, as the explanatory variable, any one of the numerical value of any one of a biological metabolite and a biological indicator or both that have a dependency relation with the concentration value of the amino acid, and the numerical value of any one of the biological metabolite and the biological indicator or both that have a dependency relation with the numerical value indicative of the biological state, or both.

5. The biological state-evaluating apparatus according to claim 4, wherein
the biological metabolite is at least one of carbohydrate, lipid, protein, peptide, mineral, and hormone, and
the biological indicator is at least one of blood glucose, blood pressure, sex, age, disease indicator, dietary habit, drinking habit, sport habit, degree of obesity, and disease history.

6. The biological state-evaluating apparatus according to claim 1, wherein the biological state-evaluating unit further includes a biological state-discriminating unit that discriminates between a healthy state and a disease state of the biological state of the subject by using the Bayesian network model created by the model creating unit and the previously obtained amino acid concentration data on the subject.

7. The biological state-evaluating apparatus according to claim 1, wherein the biological state is a state of impaired glucose tolerance.

8. The biological state-evaluating apparatus according to claim 7, wherein
the amino acid concentration data on the subject is measured from blood that is collected from the subject to whom a desired substance group consisting of one or more substances has been administered, and
the control unit further includes a determining unit that determines whether the desired substance group prevents the impaired glucose tolerance or ameliorates the state of the impaired glucose tolerance by using an evaluation result obtained by the biological state-evaluating unit.

9. A biological state-evaluating method of evaluating a biological state of a subject to be evaluated, the method is carried out with an information processing apparatus including a control unit, the method comprising:
(i) a model creating step of creating, by performing a Bayesian network method by using previously obtained amino acid concentration data on a concentration value of an amino acid and previously obtained biological state data on a numerical value indicative of the biological state, a Bayesian network model that includes, as the explanatory variables, the concentration value of the amino acid and the numerical value indicative of the biological state; and
(ii) a biological state-evaluating step of evaluating the biological state of the subject by using the Bayesian network model created at the model creating step and the previously obtained amino acid concentration data on the subject,
wherein the steps (i) and (ii) are executed by the control unit.

10. The biological state-evaluating method according to claim 9, wherein the control unit further executes an explanatory variable-selecting step of selecting, from the concentration values of the respective amino acids constituting the amino acid concentration data, a concentration value to be used as the explanatory variable for performing the Bayesian network method by a predetermined method.

11. The biological state-evaluating method according to claim 10, wherein the predetermined method is a multivariate analysis method or a search method of Bayesian network structure.

12. The biological state-evaluating method according to claim 9, wherein the Bayesian network model further includes, as the explanatory variable, any one of the numerical value of any one of a biological metabolite and a biological indicator or both that have a dependency relation with the concentration value of the amino acid, and the numerical value of any one of the biological metabolite and the biological indicator or both that have a dependency relation with the numerical value indicative of the biological state, or both.

13. The biological state-evaluating method according to claim 12, wherein
the biological metabolite is at least one of carbohydrate, lipid, protein, peptide, mineral, and hormone, and
the biological indicator is at least one of blood glucose, blood pressure, sex, age, disease indicator, dietary habit, drinking habit, sport habit, degree of obesity, and disease history.

14. The biological state-evaluating method according to claim 9, wherein the biological state-evaluating step further includes a biological state-discriminating step of discriminating between a healthy state and a disease state of the biological state of the subject by using the Bayesian network model created at the model creating step and the previously obtained amino acid concentration data on the subject.

15. The biological state-evaluating method according to claim 9, wherein the biological state is a state of impaired glucose tolerance.

16. The biological state-evaluating method according to claim 15, wherein
the amino acid concentration data on the subject is measured from blood that is collected from the subject to whom a desired substance group consisting of one or more substances has been administered, and
the control unit further executes a determining step of determining whether the desired substance group prevents the impaired glucose tolerance or ameliorates the state of the impaired glucose tolerance by using an evaluation result obtained at the biological state-evaluating step.

17. A biological state-evaluating system configured by communicatively connecting, via a network, a biological state-evaluating apparatus that includes a control unit to evaluate a biological state of a subject to be evaluated and an information communication terminal apparatus that provides amino acid concentration data on a concentration value of an amino acid of the subject, wherein
the information communication terminal apparatus includes
an amino acid concentration data-sending unit that sends the amino acid concentration data on the subject to the biological state-evaluating apparatus; and
an evaluation result-receiving unit that receives an evaluation result relating to the biological state of the subject that is sent from the biological state-evaluating apparatus;
the control unit of the biological state-evaluating apparatus includes
an amino acid concentration data-receiving unit that receives the amino acid concentration data on the subject that is sent from the information communication terminal apparatus;
a model creating unit that creates, by performing a Bayesian network method by using the previously obtained amino acid concentration data and previously obtained biological state data on a numerical value indicative of the biological state, a Bayesian network model that includes, as the explanatory variables, the concentration value of the amino acid and the numerical value indicative of the biological state;
a biological state-evaluating unit that evaluates the biological state of the subject by using the Bayesian network model created by the model creating unit and the amino acid concentration data on the subject that is received by the amino acid concentration data-receiving unit; and
an evaluation result-sending unit that sends the evaluation result obtained by the biological state-evaluating unit to the information communication terminal apparatus.

18. A biological state-evaluating program product that makes an information processing apparatus including a control unit execute a method of evaluating a biological state of a subject to be evaluated, the method comprising:
(i) a model creating step of creating, by performing a Bayesian network method by using previously obtained amino acid concentration data on a concentration value of an amino acid and previously obtained biological state data on a numerical value indicative of the biological state, a Bayesian network model that includes, as the explanatory variables, the concentration value of the amino acid and the numerical value indicative of the biological state; and
(ii) a biological state-evaluating step of evaluating the biological state of the subject by using the Bayesian network model created at the model creating step and the previously obtained amino acid concentration data on the subject,
wherein the steps (i) and (ii) are executed by the control unit.

19. A computer readable recording medium storing the biological state-evaluating program according to claim 18.
